(19) United States
(12) Patent Application Publication
(10) Pub. No.: US 2026/0243039 A1
(43) Pub. Date: Aug. 20, 2026

(54) SOLAR MODULE ARRAY LEVELLING MECHANISM AND INSTALLATION METHOD

(71) Applicant: Pegasus Solar Inc, Richmond, CA (US)

(72) Inventors: Erich Kai Stephan, sRichmond, CA (US); Ian Wogan, Richmond, CA (US); Ian Lennox, Richmond, CA (US); Matthew Williams, Richmond, CA (US)

(21) Appl. No.: 19/542,531

(22) Filed: Feb. 17, 2026

Related U.S. Application Data
(60) Provisional application No. 63/758,937, filed on Feb. 14, 2025.

(51) Int. Cl. E02D 5/56; E02D 7/22; H02S 20/10; H02S 20/30

(52) U.S. Cl. CPC E02D 5/56; E02D 7/22; H02S 20/10; H02S 20/30

(57) ABSTRACT

Embodiments of the present invention may include a swivel bracket assembly for mounting to a micropile. The assembly may include a swivel bracket. The assembly may further include a crimp tube shaped to fit over a distal segment of the micropile as a sleeve, the crimp tube crimpable to seize the micropile. The assembly may further include a leveling screw that threadably engages the swivel bracket at an upper end of the distal segment of the micropile and extends into the crimp tube, wherein the leveling screw is rotated to change a position of the swivel bracket relative to the micropile.

### CROSS-REFERENCE TO RELATED APPLICATIONS

The present patent application claims the priority benefit of U.S. provisional patent application No. 63/758,937 filed Feb. 14, 2025, the disclosure of which is incorporated by reference herein.

### BACKGROUND OF THE INVENTION

### Field of the Art

The present invention generally relates to solar mounting systems. More specifically, the present invention relates to installing solar modules in an uneven terrain.

### Description of the Related Art

Currently, solar modules are supported at an angle relative to the horizon set by the geometry of a support bracket and underlying substructure. Often these substructures need to be installed at a precise height, or the solar modules are not installed coplanar. The present invention demonstrates a method to compensate for substruction elevation variation by including a levelling apparatus in the support bracket.

### SUMMARY OF THE CLAIMED INVENTION

Embodiments of the present invention may include a swivel bracket assembly for mounting to a micropile. The assembly may include a swivel bracket. The assembly may further include a crimp tube shaped to fit over a distal segment of the micropile as a sleeve, the crimp tube crimpable to seize the micropile. The assembly may further include a leveling screw that threadably engages the swivel bracket at an upper end of the distal segment of the micropile and extends into the crimp tube, wherein the leveling screw is rotated to change a position of the swivel bracket relative to the micropile.

Embodiments of the present invention may include a method of installing a swivel bracket assembly. The method may include aligning a crimp tube coaxially with a micropile protruding vertically above a terrain. The method may further include lowering a swivel bracket assembly onto the micropile until a leveling screw abuts an upper distal end of the micropile, wherein the leveling screw threadably engages the swivel bracket. The method may further include rotating the leveling screw to raise or lower the swivel bracket assembly to a selected height above the terrain.

### BRIEF DESCRIPTION OF THE DRAWINGS

FIG. 1. is an exploded view of the components of an exemplar swivel bracket assembly.

FIG. 2 is an isometric view of an exemplar swivel bracket assembly.

FIG. 3 is a side view of an exemplar swivel bracket.

FIG. 4 is an isometric exploded view of a swivel bracket assembly.

FIGS. 5A-5E illustrate an exemplar assembly of a swivel bracket assembly.

FIGS. 6A-6E illustrate an exemplar assembly of a swivel bracket assembly.

FIGS. 7A-7E illustrate an exemplar assembly of a swivel bracket assembly.

FIGS. 8A-8D illustrate isometric views of an exemplar installation sequence for a swivel bracket.

FIGS. 9A-9D illustrate isometric views of an exemplar installation sequence for a swivel bracket.

FIGS. 10A-10C are side views of a swivel bracket installed on a micropile.

FIGS. 11A-11C are close-up cross sectional views of the swivel bracket on a micropile.

FIG. 12 is a close-up side view of the crimp tube installed on a micropile.

FIGS. 13A-13H are top-down cross sectional views of a crimp tube and a first crimp.

FIG. 14 is an isometric view of a micropile partially installed into a terrain.

FIG. 15 is a zoomed-out isometric view of a partially constructed solar module array.

FIG. 16 is a side view of a column of micropiles installed in a terrain.

FIG. 17 is an isometric view of a solar module array.

FIG. 18A is an isometric view of a solar module array.

FIG. 18B is a top-down view of a solar module array.

FIG. 19 is an isometric view of an exemplar solar module in a solar module array.

FIG. 20 is an underside view of a solar module.

FIG. 21A is an isometric view of a solar module array.

FIG. 21B is a top-down view of a solar module array.

FIG. 22 is a low isometric view of a solar module array.

FIG. 23 is a close-up side view of an exemplar swivel bracket.

FIG. 24 is a low isometric view of a solar module array.

FIGS. 25A and 25B are side views of a solar module array.

FIG. 26A is an isometric view of a solar module array.

FIG. 26B is a top-down view of a solar module array.

FIG. 27 is an isometric view of a solar module array.

FIG. 28A is an isometric view of a solar module array.

FIG. 28B is a side view of a solar module array.

FIG. 28C is a front view of a solar module array.

FIG. 29A is an isometric view of a solar module array.

FIG. 29B is a side view of a solar module array.

FIG. 30A is an isometric view of a solar module array.

FIG. 30B is a side view of a solar module array.

FIG. 31 is an isometric view of a solar module array.

FIG. 32 is an isometric view of a solar module array.

FIG. 33 is an isometric view of a centerline swivel assembly.

FIG. 34 is a plan-front view of a centerline swivel assembly.

FIG. 35 is a plan-side view of a centerline swivel assembly.

FIG. 36 is an isometric view of centerline swivel assemblies on micropiles.

FIG. 37 is close-up isometric view of a centerline swivel assembly.

FIG. 38 is an underside view of a centerline swivel assembly.

FIG. 39 is an isometric view of centerline swivel assemblies on micropiles

FIG. 40 is an isometric view of module columns.

FIG. 41 is an isometric view of a solar module array.

FIG. 42 is a top-down view of a solar module array.

FIG. 43 is an isometric view of a solar module.

FIG. 44 is an isometric view of a solar module array.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

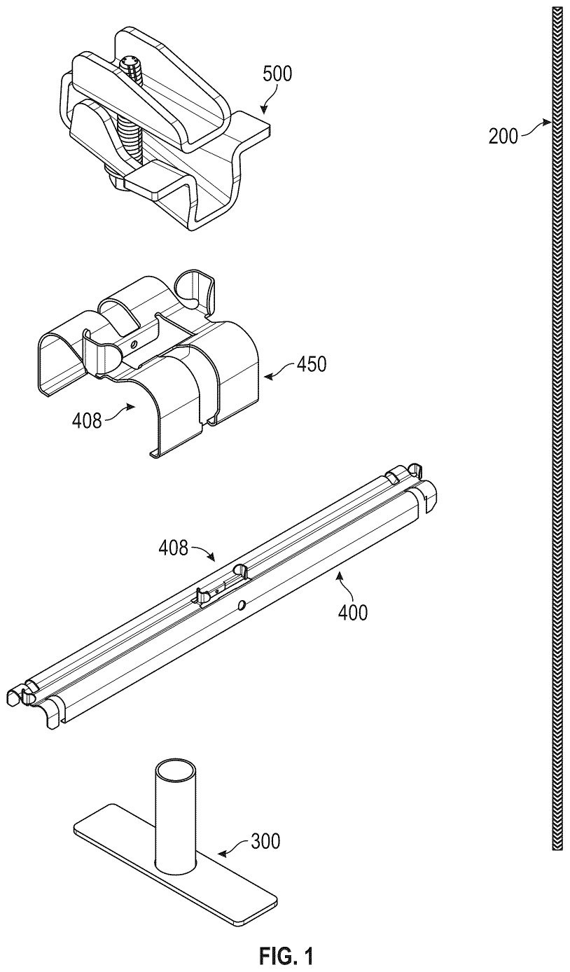

FIG. 1 depicts a collection of components used to support one or more solar modules 103 (not shown), representing one example embodiment of the present invention. The set of components may include a plurality of micropiles 200, bases 300, swivel brackets 408, and module clamps 500, and in some cases other components not depicted. Each of these will be described in more detail in the following figures. A swivel bracket 408 may be configured either as a mid-swivel bracket assembly 400 or an end-swivel bracket assembly 450, wherein an end-swivel bracket assembly 450 is a shorter version of a mid-swivel bracket assembly 400 and configured to receive at least two module clamps 500, whereas a mid-swivel bracket assembly 400 is longer and configured to receive at least four module clamps 500.

Micropiles 200 may for example be a rebar of 0.5 to 1.0 inch in diameter. Micropiles 200 may have a pattern of ridges, knurling, grooves, bumps, or other features protruding from its body. Micropiles 200 may be made from steel or iron, and may have a corrosion protection coating, such as galvanization, disposed on their surface. In other example embodiments, Micropiles 200 may be a hollow tube 0.5 to 2.0 inches in exterior diameter. In this example, the hollow tube may made from pre-galvanized pipe with a steel or iron substrate.

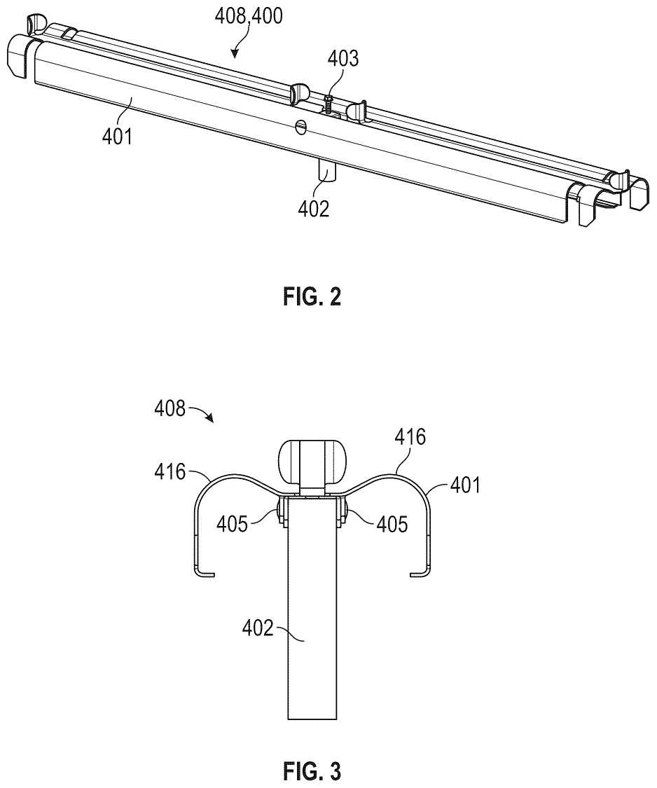

FIG. 2 depicts an isometric view of a swivel bracket 408 configured as a mid-swivel bracket assembly 400, where a crimp tube 402 is pivotally attached to a mid-swivel bracket 401 at a site substantially mid-body of the mid-swivel bracket 401, representing one example embodiment of the present invention. A levelling screw 403 may be accessible from above the mid-swivel bracket 401 through one or more apertures disposed in the top surface of the mid-swivel bracket 401.

FIG. 3 depicts an end view of the swivel bracket 408, showing how the crimp tube 402 may be pivotally attached to the swivel bracket 408 with one or more pivot fasteners 405. A pivot fastener 405 may be a screw, rivet, press-fit pin, rod, tube, or other suitable component. In some cases, the pivot fastener 405 or a pair of pivot fasteners 405 may be able to withstand a shear force of up to 20,000 newtons force. As depicted, the crimp tube 402 may be attached at substantially the centerline of the swivel bracket 408 according to this view. The top distal end of the crimp tube 402 may terminate just below or coincident with a top surface of the mid-swivel bracket 401, such as on a rounded hem as shown on either side of the mid-swivel bracket 401.

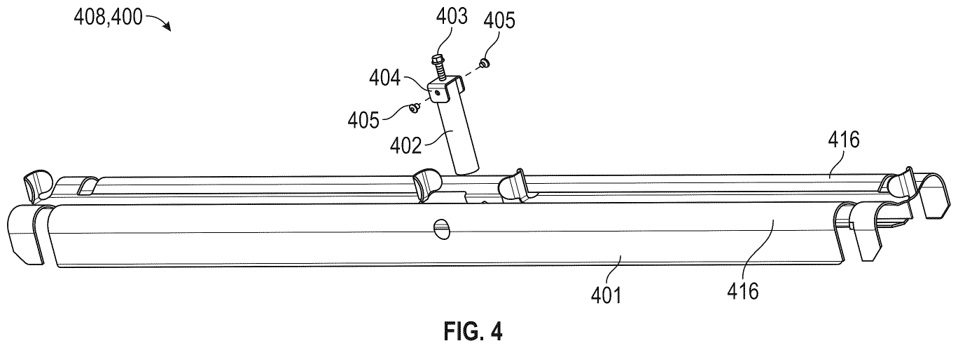

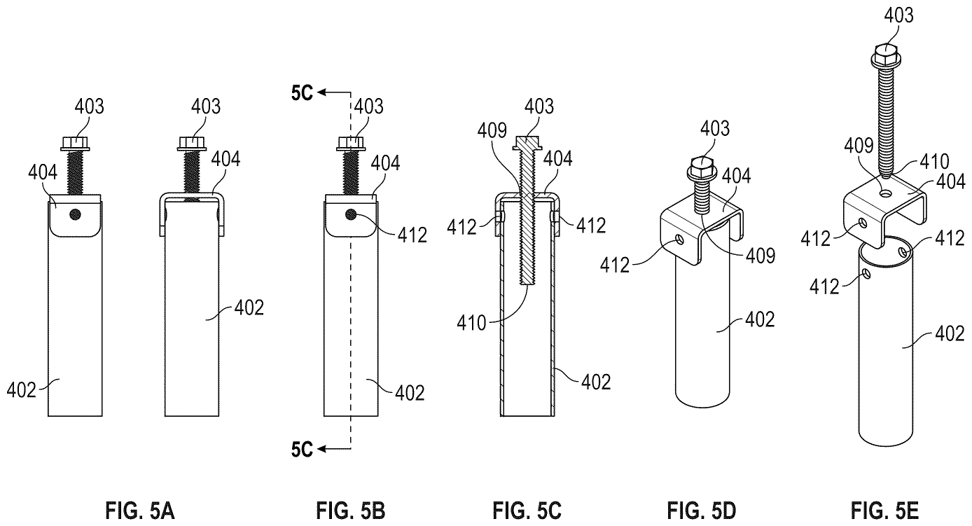

FIG. 4 depicts an isometric exploded view of a swivel bracket 408 prior to assembly. The swivel bracket 408 may consist of a mid-swivel bracket 401, a crimp tube 402, a levelling screw 403, and one or more pivot fasteners 405 configured to pivotally secure the crimp tube 402 to the mid-swivel bracket 401. In some embodiments (such as detailed in FIG. 5), a levelling screw plate 404 may reside over a top distal end of the crimp tube 402 and configured to threadably engage with the levelling screw 403.

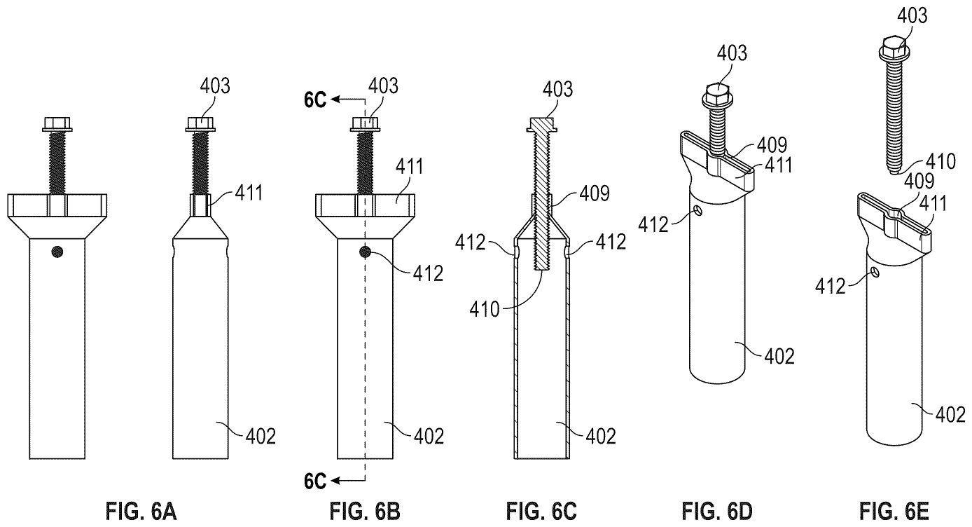

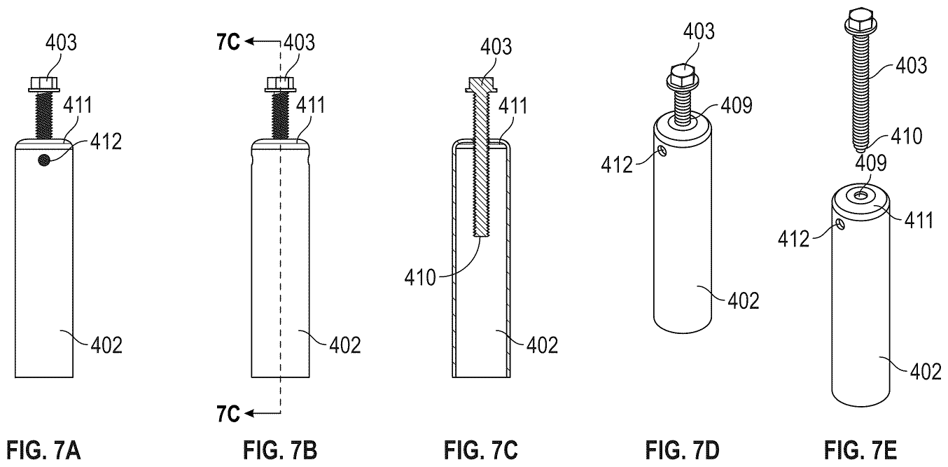

FIGS. 5A through 5B depict one example of the assembly and functionality of a crimp tube 402 with a levelling screw 403, with alternative embodiments shown in FIGS. 6 and 7. It should be understood that the embodiments in FIGS. 6 and 7 may be used instead of the embodiment in FIG. 5 in all cases of the present invention, including in all other figures presented. The levelling screw 403 may be a threaded fastener, such as a bolt or screw, and may be made from carbon steel or stainless steel. The levelling screw 403 may have a protective coating, such as a zinc or zinc-nickel, or coating formed by galvanization. The levelling screw 403 may have a hex head, torx head, hexagonal socket head, or Philips head, or any similar feature on one distal end configured to receive a tool for rotating the levelling screw 403. The levelling screw 403 may have threads along its shank with between 15 and 30 threads per inch of length, and the main threaded body of levelling screw 403 may have a diameter of between 0.1 and 0.5 inches. The threaded portion of the levelling screw 403 may be between 0.5 and 6.0 inches long, with some embodiments having a threaded portion between 1.5 and 3.5 inches long. The levelling screw 403 may have a levelling screw tip 410 at a distal end opposite the head. The levelling screw tip 410 may have a flat surface as depicted, and may be tapered with one or more thread-cutting features near the distal end, as depicted. The levelling screw tip 410 may be configured to cut or roll threads into a levelling threaded aperture 409 on a first installation of the levelling screw 403 into the aperture.

FIGS. 5A through 5E are various views of an assembly of a crimp tube 402 and levelling screw 403 using a levelling screw plate 404. As shown in FIGS. 5A and 5B, the levelling screw plate 404 has a flat body with flanges angled down on either end configured to substantially align with an outside surface of the crimp tube 402. The levelling screw plate 404 may have one or more crimp tube pivot apertures 412 disposed on the side flanges that are configured to align substantially cordially (coaxially) with one or more crimp tube pivot apertures 412 disposed laterally through the crimp tube 402 and configured to receive a pivot fastener 405 (not shown). FIG. 5C is a section view of FIG. 5B, depicting a levelling screw 403 threadably engaged with a levelling threaded aperture 409, where the levelling threaded aperture 409 is disposed in substantially the center of a top surface of a levelling screw plate 404. As shown, the levelling screw plate 404 and levelling threaded aperture 409 are positioned so that the levelling screw 403 protrudes into the central cavity of the crimp tube 402. FIGS. 5D and 5E are isometric assembled and exploded views of FIG. 5A for additional understanding of the structure.

FIGS. 6A through 6E are various views of an assembly containing a crimp tube 402 and a levelling screw 403 without a levelling screw plate 404, and instead where the crimp tube 402 has a formed end 411 on its top distal end, representing one example embodiment of the present invention. As shown in FIGS. 6A and 6B, the formed end 411 is the top end of the crimp tube 402 above the crimp tube pivot aperture 412. The long axis of the formed end 411 may be substantially perpendicular with the axis of the crimp tube pivot aperture 412, as depicted. In other words, crimp tube 402 may be axially flattened into formed end 411 except for threaded aperture 409. A levelling threaded aperture 409 may be formed in the center of the formed end 411 and configured to receive the levelling screw 403. The crimp tube pivot aperture 412 may be configured to receive one or more pivot fasteners 405 when the crimp tube 402 is installed in a swivel bracket 408. FIG. 6C is a sectioned view of FIG. 6B, depicting the levelling screw 403 threadably engaged with the levelling threaded aperture 409. As shown, the levelling threaded aperture 409 is positioned so that the levelling screw 403 protrudes into the central cavity of the crimp tube 402. FIGS. 6D and 6E are isometric assembled and exploded views of FIG. 6A for additional understanding of the structures. In this example embodiment, the formed end 411 may be formed into the crimp tube 402 using a set of tools that compress the crimp tube 402 from either side, or laterally. The crimping tools may move along a positive and negative X axis, and a plug or pin may be inserted into the crimp tube 402 before the formed end 411 is formed in order to create the levelling threaded aperture 409.

FIGS. 7A through 7E are various views of an assembly that contains a crimp tube 402 and a levelling screw 403 but no levelling screw plate 404. Rather than a levelling screw plate, the crimp tube 402 has an alternative version of a formed end 411 on its top distal end, representing one example embodiment of the present invention. As shown in FIGS. 7A and 7B, the formed end 411 is formed into the top end of the crimp tube 402 above the crimp tube pivot aperture 412. The long axis of the formed end 411 may be substantially perpendicular to the axis of the crimp tube pivot aperture 412, as depicted. The levelling threaded aperture 409 may be formed in the center of the formed end 411, and configured to receive the levelling screw 403. The crimp tube pivot aperture 412 may be configured to receive one or more pivot fasteners 405 when the crimp tube 402 is installed into a swivel bracket 408. FIG. 7C is a sectioned view of FIG. 7B, depicting the levelling screw 403 threadably engaged with the levelling threaded aperture 409. As shown, the levelling threaded aperture 409 is positioned so that the levelling screw 403 protrudes into the central cavity of the crimp tube 402. FIGS. 7D and 7E are isometric assembled and exploded views of FIG. 7A for additional understanding of the structures. In this example embodiment, the end of the crimp tube 402 may be formed by use of one or more tools that compress the crimp tube 402 along its length from the top distal end. In other example methods, the crimp tube 402 may be rotated along its primary axis, and a tool may be pressed laterally against the top distal end of the crimp tube 402 to gradually form and move the material of the crimp tube 402 towards the axis of rotation until an aperture remains that is substantially the diameter of the levelling threaded aperture 409.

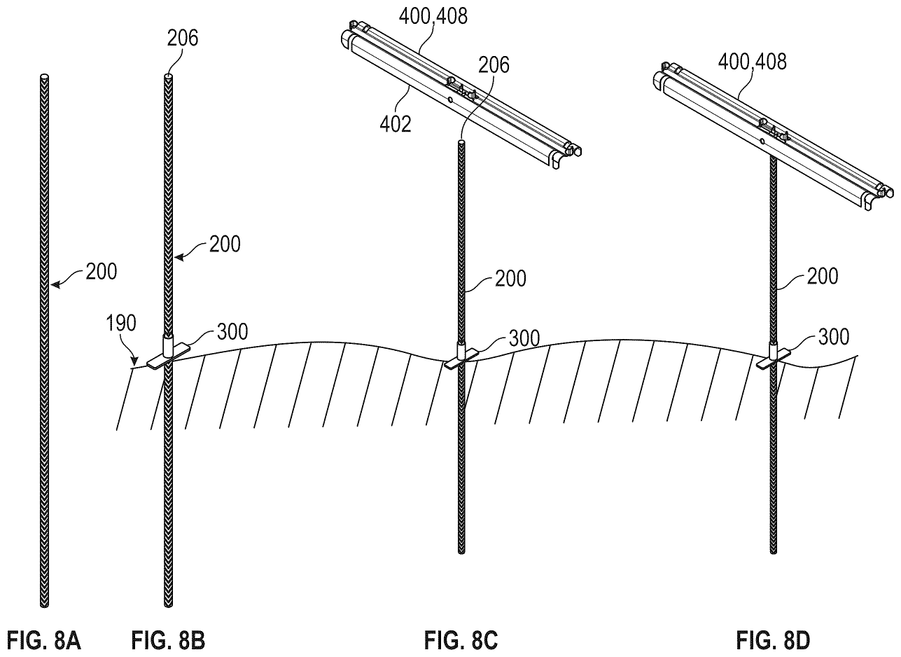

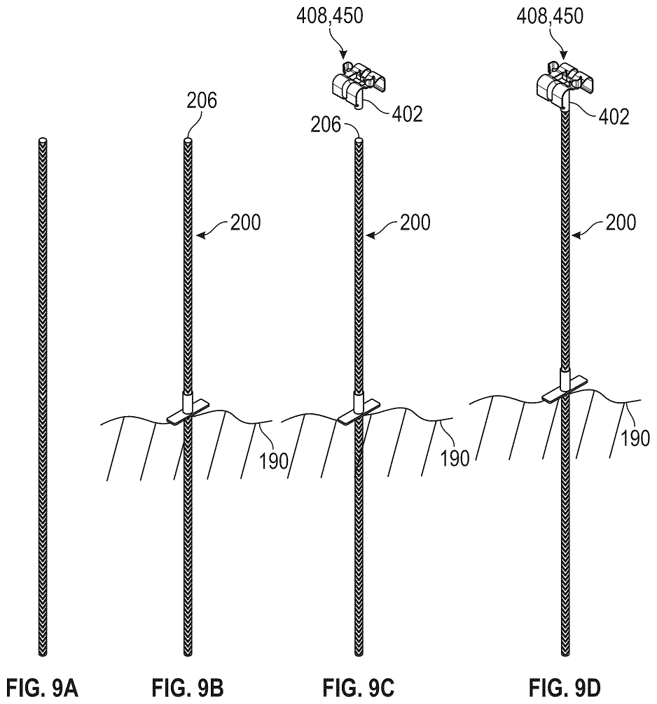

FIGS. 8A-8D and 9A-9D are isometric views of an installation sequence for installing a swivel bracket 408 onto a micropile 200, representing one example embodiment of the present invention. The swivel bracket in FIGS. 8A-8D is end-swivel bracket assembly 450, and the swivel bracket in FIGS. 9A-9D is a mid-swivel bracket assembly 400.

FIG. 8A is an isometric view of a micropile 200 partially installed into the terrain 190. FIG. 8B depicts a potential next step where a base 300 is installed over the micropile 200 and abuts the terrain 190. FIG. 8C depicts a potential next step where an end-swivel bracket assembly 450 is positioned over the micropile tip 206 so that the crimp tube 402 is substantially coaxial with the micropile 200. FIG. 8D depicts a potential next step where the end-swivel bracket assembly 450 is lowered onto the micropile 200 until the levelling screw tip 410 (not shown) abuts the micropile tip 206 and the crimp tube 402 is over the micropile 200.

Likewise, FIG. 9A is an isometric view of a micropile 200 partially installed into the terrain 190. FIG. 9B depicts a potential next step where a base 300 is installed over the micropile 200 and abuts the terrain 190. FIG. 9C depicts a potential next step where the mid-swivel bracket assembly 400 is positioned over the micropile tip 206 so that the crimp tube 402 is substantially coaxial with the micropile 200. FIG. 9D depicts a potential next step where the mid-swivel bracket assembly 400 is lowered onto the micropile 200 until the levelling screw tip 410 (not shown) abuts the micropile tip 206 and the crimp tube 402 is over the micropile 200.

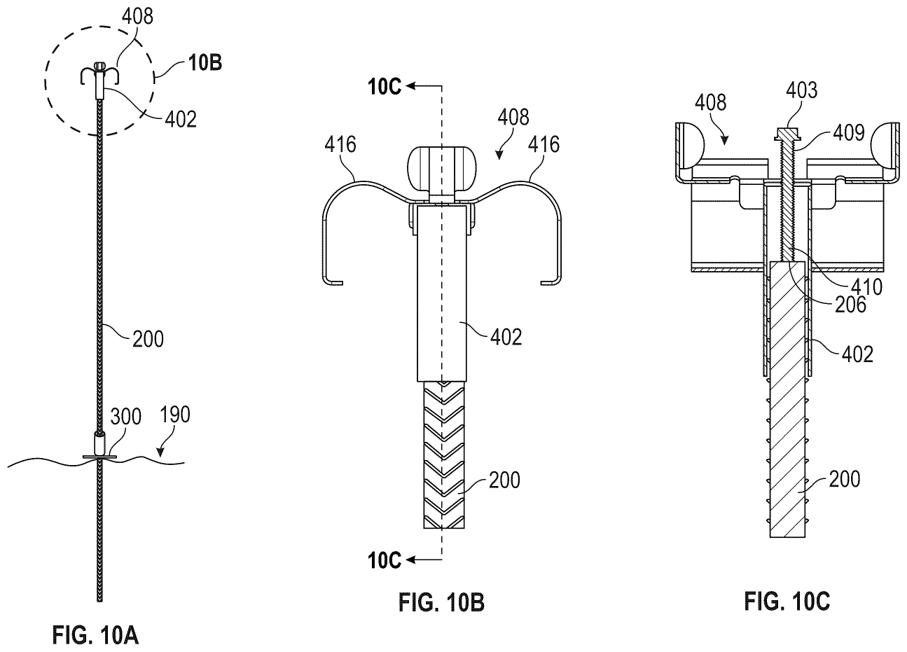

FIGS. 10A-10C are side views of a swivel bracket 408 installed on a micropile 200, representing one example embodiment of the present invention. FIG. 10A is a side view with the micropile 200 partially installed into the terrain 190 and the base 300 installed over the micropile 200 and positioned to abut the terrain 190. The swivel bracket 408 is installed on a skyward, distal end of the micropile 200. FIG. 10B is a close-up side view of the swivel bracket 408 installed on the micropile 200, with a crimp tube 402 sleeved over the end of the micropile 200. FIG. 10C is a sectioned view, depicting the interactions of the various components inside the structure shown in FIG. 10B. In this example embodiment, a levelling screw 403 is positioned substantially halfway along its threaded length in the threaded aperture 409, with the tip 410 of the levelling screw extending into the inner cavity of the crimp tube 402. The levelling screw tip 410 abuts the micropile tip 206, supporting the swivel bracket 408 above the micropile tip 206 by the force of gravity, while the crimp tube 402 coaxially fits over a distal end of the micropile 200 to substantially constrain the swivel bracket 408 in an X and Y plane perpendicular to the longitudinal axis of the micropile 200. Notably, the swivel bracket 408 and the crimp tube 402 are free to rotate around the axis of either the levelling screw 403 or the micropile 200, or of both simultaneously.

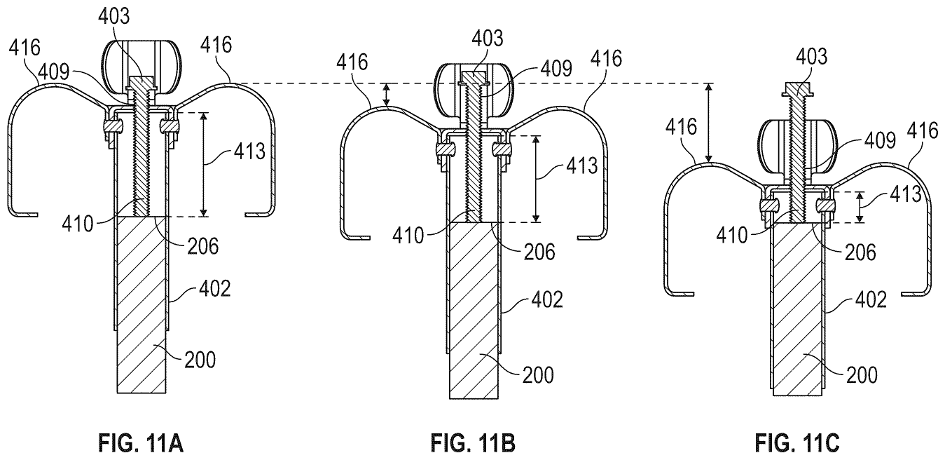

FIGS. 11A to 11C are close-up sectioned views of the swivel bracket 408 on a skyward distal end of the micropile 200 with the levelling screw 403 threadably engaged to different distances through the levelling threaded aperture 409. As a result, the swivel bracket 408 is at different heights above the micropile tip 206. In FIG. 11A, the levelling threaded aperture 409 is positioned proximal to the head of the levelling screw 403 along the threaded section of the levelling screw, resulting in a first position levelling height 413 at a maximum value, such as 25 to 250 millimeters. With the levelling threaded aperture 409 in this position, the crimp tube 402 may extend below the micropile tip 206 a distance sufficient to secure the crimp tube 402 to the micropile 200 by crimping, with an overlap distance of twenty to two-hundred millimeters, or in some cases, twenty to one-hundred millimeters. FIG. 11B depicts the levelling threaded aperture 409 positioned about halfway along the threaded section of the levelling screw 403, resulting in a second levelling height 413 that is less than the first levelling height 413. FIG. 11C depicts the levelling threaded aperture 409 positioned near the levelling screw tip 410, resulting in a minimum levelling height 413, such as for example zero to twenty millimeters.

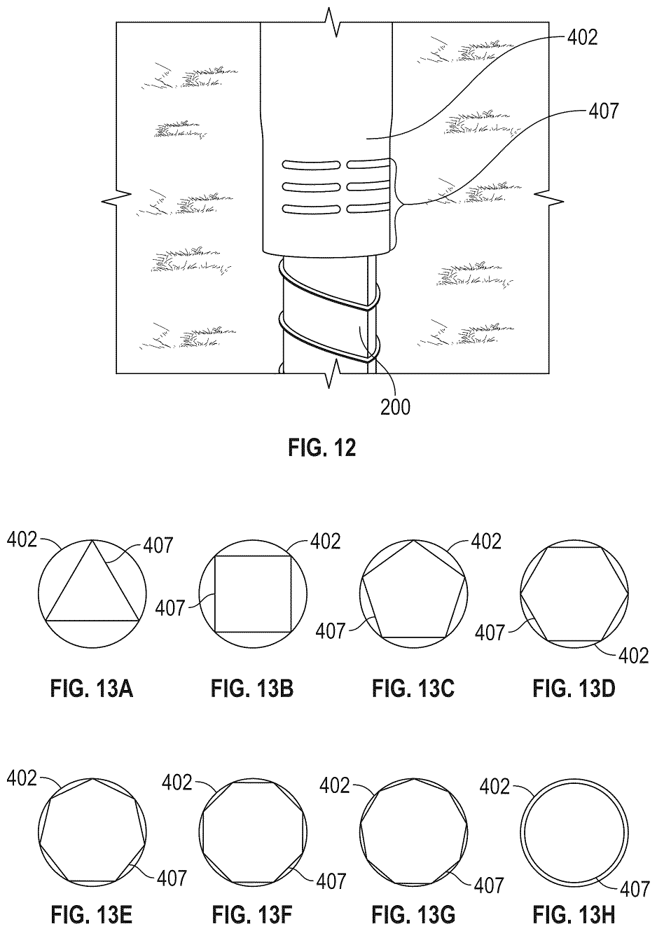

FIG. 12 is a close-up side view of the crimp tube 402 installed on the micropile 200, where a crimp 407 secures and affixes the crimp tube 402 to the micropile 200. As such, the crimp tube 402 is transitioned to a fixed crimp tube 402′ after the crimp has been applied. The crimp may be a permanent deformation of the crimp tube 402 that causes the inner walls of the crimp tube 402 to compress onto (i.e., seize) the micropile 200. The crimp 407 may be caused by two or more dies compressing the outer surface of the crimp tube 402 with a force sufficient to cause the material of the crimp tube 402 to yield. The crimp 407 may be configured to secure the crimp tube to the micropile 200 with sufficient force to withstand between 2000 and 9000 newtons force in a positive or negative direction along the primary axis (vertical direction) of the micropile 200. In this example, the crimp 407 is a series of three imprints in a hexagonal form spaced vertically along the axis of the fixed crimp tube 402′.

FIGS. 13A through 13H are top-down section views of the crimp tube 402 and a first crimp 407, depicting various patterns that could be imprinted around the circumference of crimp tube 402 by the crimping. For example, FIG. 13D depicts a hexagonal pattern, and 13F depicts an octagonal pattern. While not depicted, it should be assumed that transition surfaces between adjacent flat surfaces of a crimp 407 may be rounded, such as shown in FIG. 12.

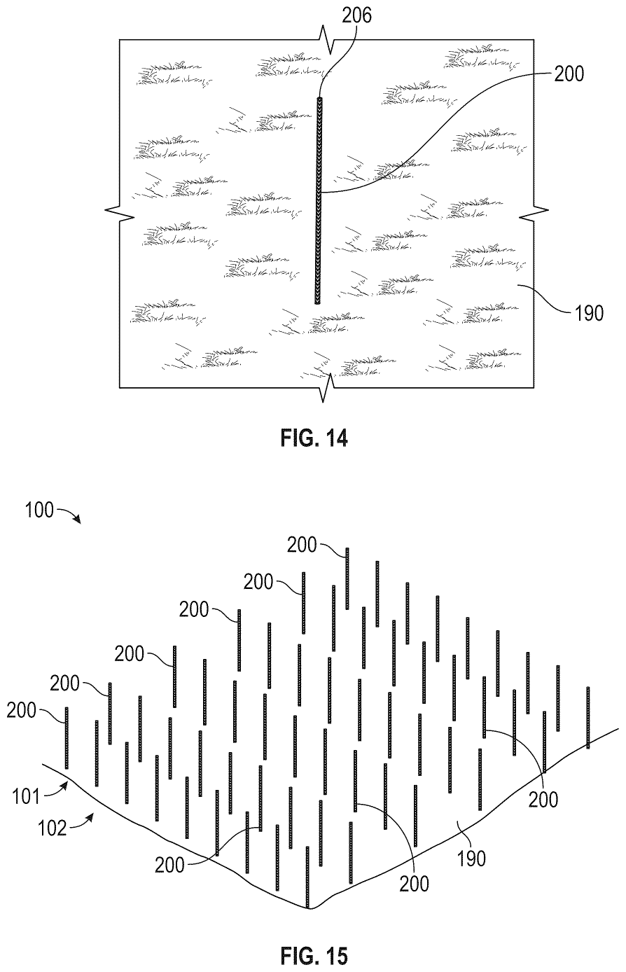

FIGS. 14 through 25B depict various installation methods of the components and functions that result in a solar module being substantially coplanar with an adjacent solar module, representing various example embodiments of the present invention.

FIG. 14 depicts a first micropile 200 partially installed into a terrain 190, with the upper tip 206 of the micropile positioned a desired distance, for example between two-hundred and fifteen hundred millimeters, above the terrain. The micropile 200 may be installed perpendicular to the terrain 190, or perpendicular to the earth horizon where the terrain 190 is at an angle to the micropile 200.

FIG. 15 is a zoomed-out view showing a partially constructed solar module array 100, wherein a plurality of micropiles 200 are installed in the terrain 190. The micropile columns may be configured as short micropile columns 101 and tall micropile columns 102, wherein the average height of the micropile tips 206 above the terrain 190 in a short micropile column 101 is less than the average height of the micropile tips 206 above the terrain 190 in a tall micropile column 102.

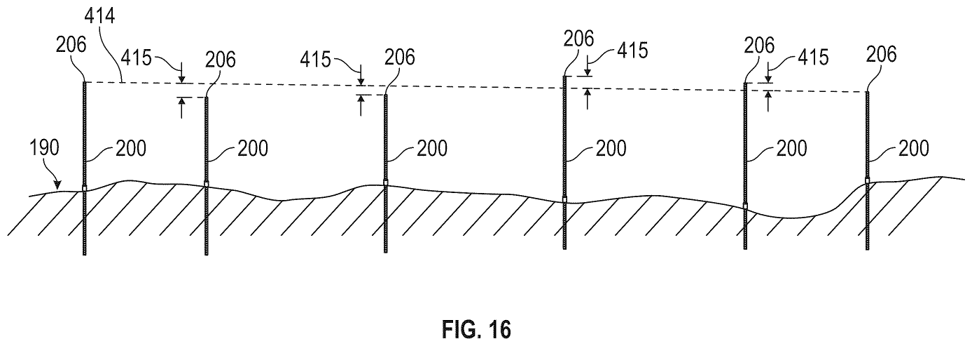

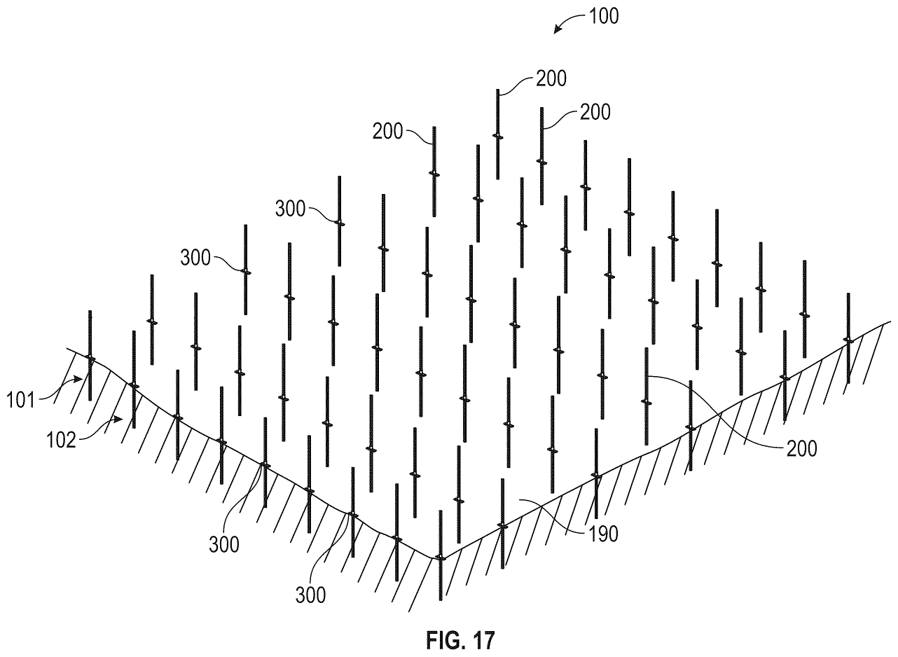

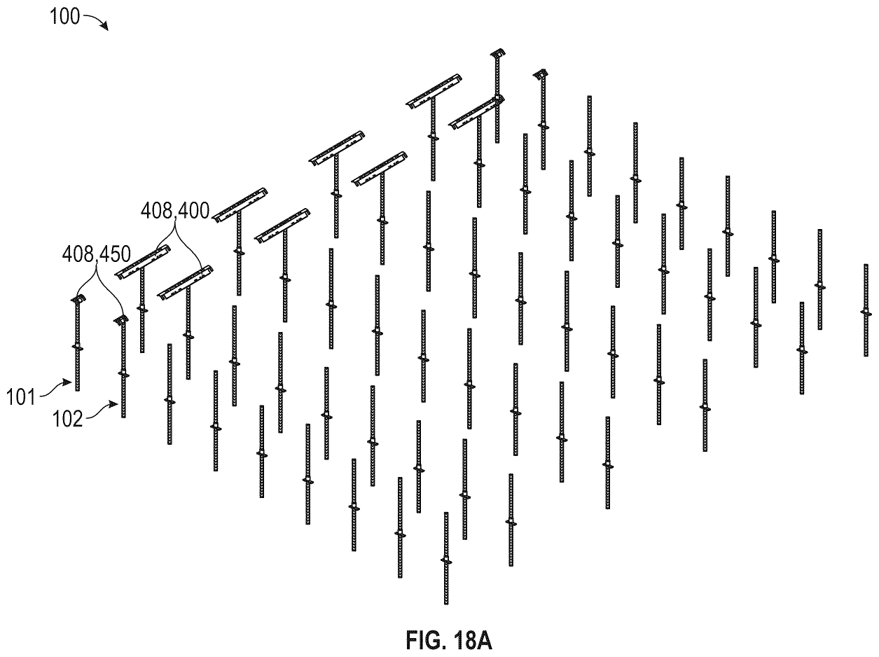

FIG. 16 is a side profile view of a first column of micropiles 200 installed in the terrain 190, with an elevation plane 414 defined as the elevation plane coincident between the tip of the first micropile in the column and the tip of the last micropile in the column, representing one example embodiment of the present invention. The terrain 190 may be flat, angled, undulating, or uneven as depicted. The micropiles 200 in the middle of the micropile column may be driven into the terrain 190 at various depths so that the tips of the micropiles in the column are coincident with the elevation plane or at a distance above or below the elevation plane by an offset distance 415 from the elevation plane. In some example embodiments, the offset 415 may be equal to or less than 150 millimeters. In other example embodiments, the offset 415 may be equal to or less than the maximum value of the levelling height 413. In this way, when a swivel bracket 408 is installed on the micropile, the swivel bracket 408 can be levelled using a levelling screw 403 so that module contact flanges 416 of the swivel brackets 408 are coplanar within a suitable distance, such as within 10, 15, or 20 millimeters.

As a potential installation method, a first micropile may be installed in the first row of a first column of micropiles to a first height above the terrain, and a last micropile may be installed in the last row of the first column to a second height above the terrain, the heights arranged to produce a short micropile column. As a potential next step, one or more micropiles may be installed between the first and last micropiles in the first column, so that the tips of the micropiles between the first and last micropiles are substantially near the plane defined by the tips of the first and last micropiles. In some example embodiments, the tips of the micropiles between the first and last micropiles in the first column may be within 150 millimeters of the line, plane, or elevation defined by the tips of the first and last micropiles. In other example embodiments, the tips of the micropiles between the first and last micropiles in the first column may be above or below the line, plane, or elevation defined by the tips of the first and last micropiles by half the maximum value of the levelling height 413.

As an alternative installation method, a plurality of micropiles 200 within a first column of micropiles 200, such as short micropile column 101, may be installed in any sequence, such as from a first micropile 200, then a second micropile 200, up to a last micropile 200, with each micropile 200 installed into the terrain 190 such that all micropile tips 206 are substantially planar. For example, all micropile tips 206 in a column may be within 150 millimeters of an average plane, or within the distance of the maximum value of the levelling height 413 above an average plane defined by all micropile tips 206 within the column. As another example, the tips of the micropiles in a single column may be within 150 millimeters of the elevation plane 414, or within the distance of the maximum value of the levelling height 413 above the elevation plane. In this example, the offset from the elevation plane 415 may be calculated from a theoretical elevation plane 414 (such as from a computer or a GPS calculation) and measured as each successive micropile 200 is installed into the terrain 190.

FIG. 17 depicts a potential next step, where one or more bases 300 are each installed on one or more micropiles 200, each base positioned to abut the terrain 190. Each base 300 may be secured to a micropile 200 by a fastener, clamp, or crimp such as crimp 407 shown in FIGS. 12 and 13.

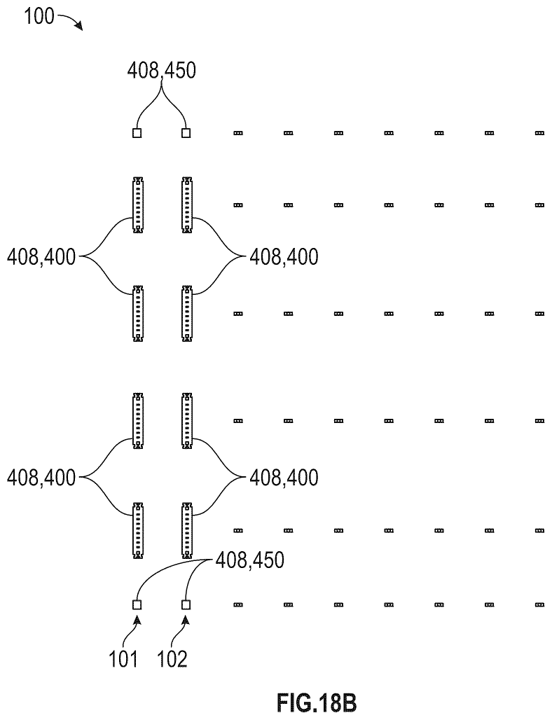

FIGS. 18A and 18B are isometric and top-down views, respectively, of a solar module array 100, showing a potential next step in the installation, where a plurality of swivel brackets 408 are each placed on the micropiles in the first and second micropile columns, such as on a short micropile column 101 and a tall micropile column 102. In some examples, an end-swivel bracket assembly 450 may be used in the first and last row, and a mid-swivel bracket assembly 400 may be used on all rows in between the first and last rows, as depicted. In this step, the crimp tube 402 may not yet be crimped.

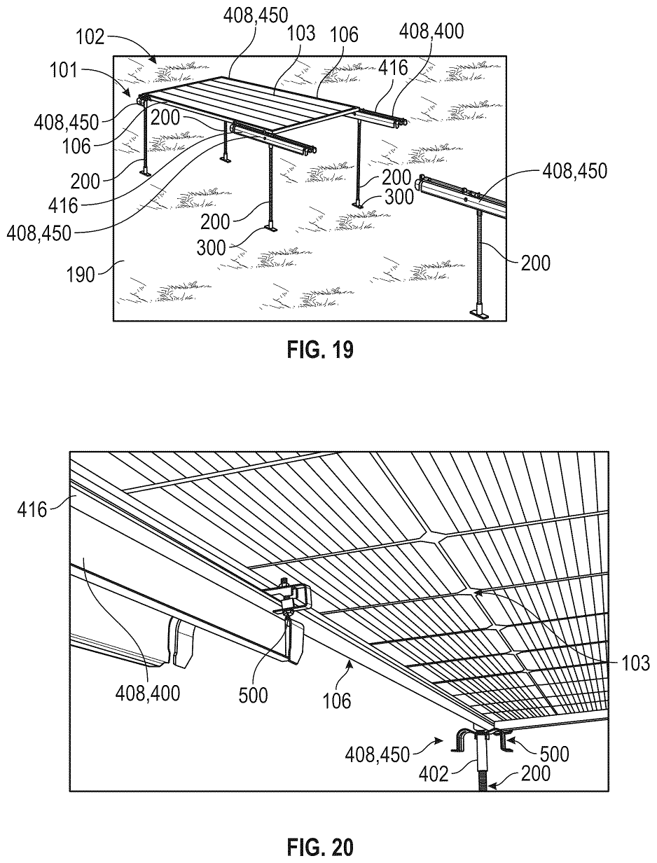

FIG. 19 depicts a potential next step, in which a first solar module 103 is installed on a first or last row of swivel brackets 408 and on a second or second-to-last row of swivel brackets 408. Each swivel bracket 408 may be rotated about the primary axis of a micropile, and pivotally around the levelling screw plate 404 or the pivot fastener 405 so that the contact flange 416 of each module is coincident with the frame 196 of the solar module or with the primary flat plane of the solar module. The solar module 103 may be positioned so that a micropile 200 is proximal to the corners of the solar module 103, as depicted, or so that one or more micropiles 200 are positioned along the length of the solar module 103.

FIG. 20 is an underside view of a solar module 103 in which one or more module clamps 500 are engaged to secure each solar module 103 to a swivel bracket 408, representing a potential next step in the installation process. The module clamp 500 may be configured to grip a lower flange of the solar module frame 106, and once fully engaged may provide an electrical bond path between the solar module frame 106 and the swivel bracket 408.

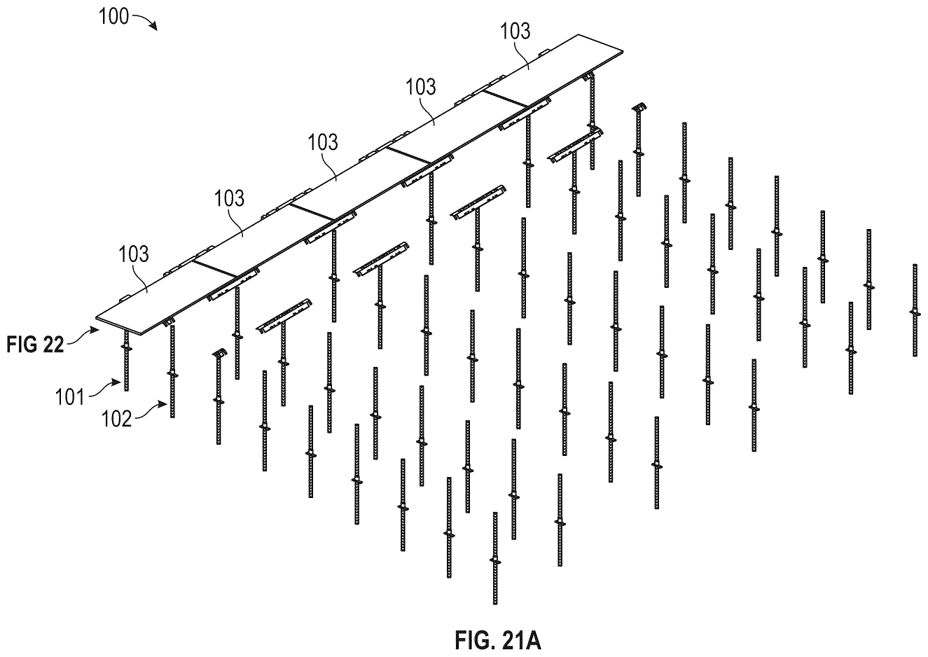

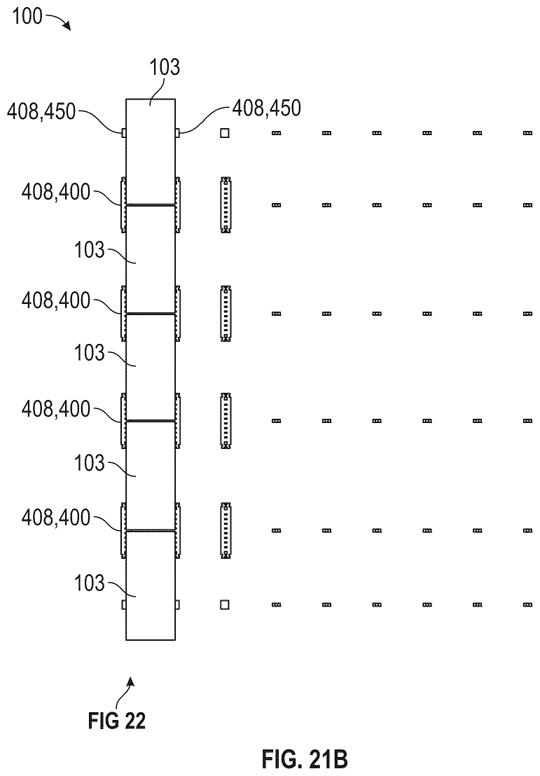

FIGS. 21A and 21B are isometric and top down views, respectively, of a solar module array 100 in which a first column of solar modules 103 is installed on the first two columns of micropiles 200, these columns being a short micropile column 101 and a tall micropile column 102, respectively. In this step, some or all of the solar modules 103 may be mechanically attached or secured and electrically bonded to their respective four swivel brackets 408.

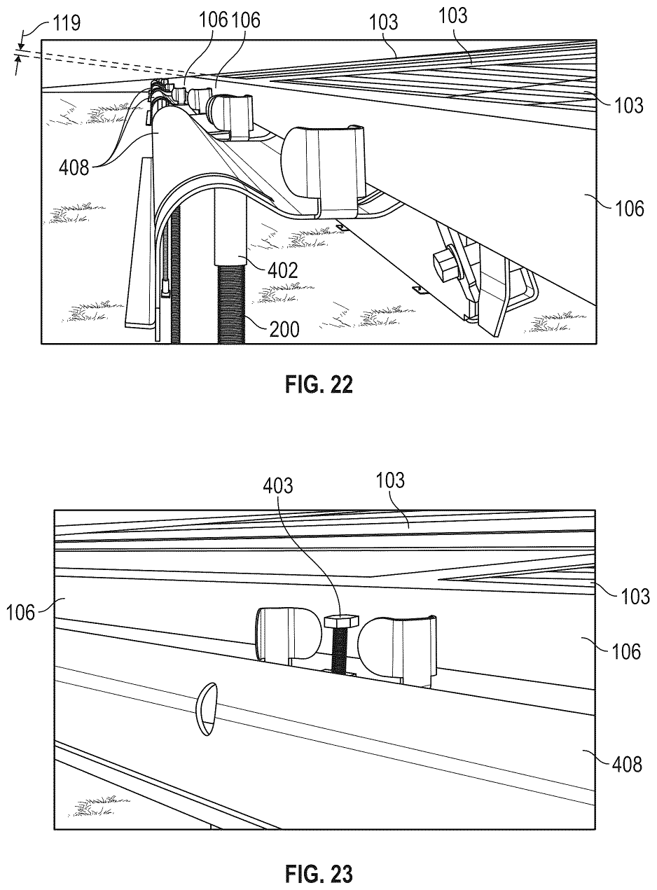

FIG. 22 is a low isometric view taken along a far edge of the solar module array 100 shown in FIG. 21B. This provides a potential variable elevation of one or more swivel brackets 408 and a resulting variable elevation and slope of each solar module frame 106, yielding a plane offset dimension 119 greater than zero, representing one example embodiment of the present invention. In this example, adjacent swivel brackets 408 within a first column of micropiles 200 have their module contact flanges 416 at different elevations. The attached solar module frame 106 of each respective solar module 103 is thus at various elevations and angles.

FIG. 23 is a close-up side view of an example of a swivel bracket 408, depicting a potential next step in the installation process. In this step, the levelling screw 403 is threadably engaged with the levelling threaded aperture 409 (not visible) to change the elevation of the swivel bracket 408, as described in FIGS. 11A-11C. The levelling screw 403 may be rotated clockwise or counterclockwise to raise or lower the swivel bracket 408 to a desired elevation.

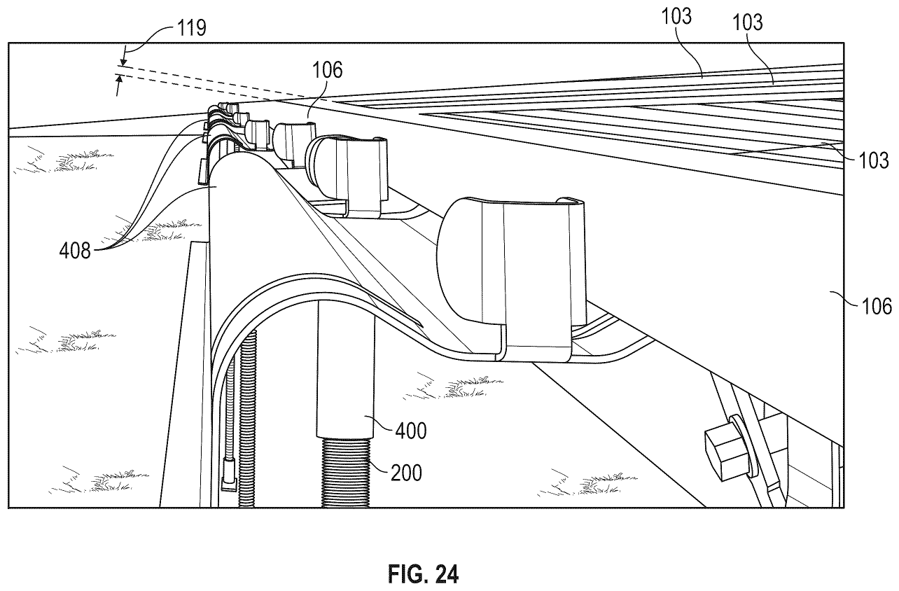

FIG. 24 is a view of FIG. 22 showing the results of changing the elevation of one or more swivel brackets 408 using their respective levelling screws 403, demonstrating a reduction in the plane offset dimension 119, representing one example embodiment of the present invention. In this example, one or more levelling screws 403 may have been rotated in a clockwise or counterclockwise direction to raise or lower the elevations of their respective swivel brackets 408 within a column of swivel brackets 408 in order to reduce the plane offset dimension 119.

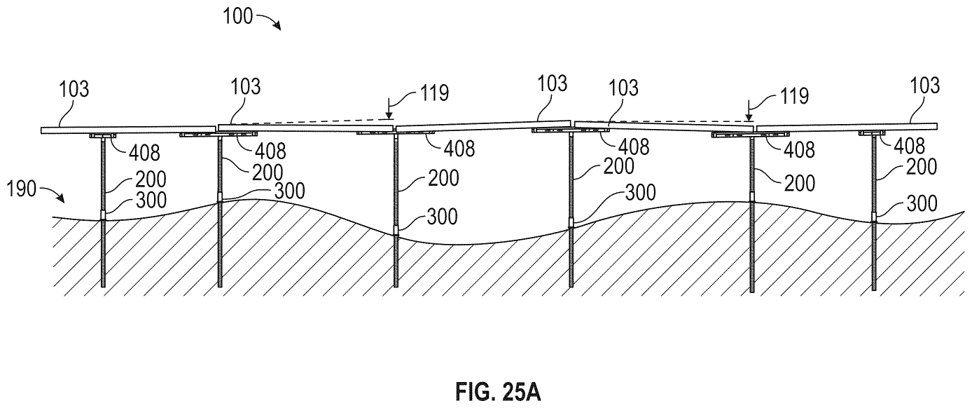

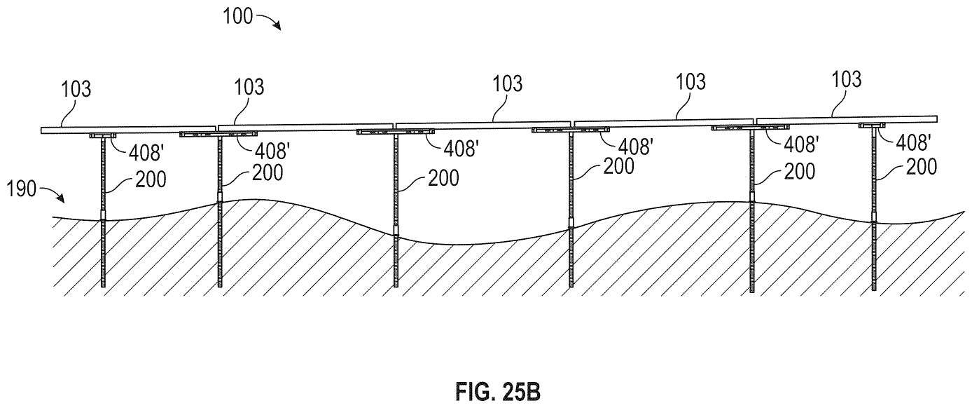

FIGS. 25A and 25B are side views of a solar module array 100 depicting the same process and results of FIGS. 22 and 24, respectively, and representing a further step from FIG. 16. As depicted in FIG. 25A, a plane offset dimension 119 may be measured as a change in elevation from one end of a solar module 103 to a second end of an adjacent solar module 103, and may occur at various locations and have various values along the length of a column in the solar module array 100. The plane offset dimension 119 may also be measured as the distance from an average elevation or plane spanning all solar modules 103 or a line of a solar module frame 106 (as depicted) in a first column of solar modules 103. The values of the plane offset dimensions 119 may be the results of positive and negative offsets from the elevation plane 415 values at each micropile 200, as exemplified in FIG. 16.

FIG. 25B depicts a potential result from levelling one or more swivel brackets 408 using levelling screws 403 as described in FIG. 11A-11C. By levelling one or more swivel brackets 408, the plane offset dimension 119 may be reduced to a distance sufficiently small to avoid damage to the photovoltaic materials in each solar module 103. In some example processes, one or more swivel brackets 408 may be levelled such that the plane offset dimension 119 at any portion along each micropile column is equal to or less than 50 millimeters per 1000 millimeters along the column, and specifically along a solar module frame 106. In other example methods, one or more swivel brackets 408 may be levelled such that the plane offset dimension 119 at any portion along each micropile column is equal to or less than 15 millimeters per meter along the column (along the solar module frame 106). FIG. 25B depicts how adjacent solar modules 103 within a column of solar modules 103 can also be substantially co-planar even when the terrain 190 varies in height and slope.

In other example embodiments not shown, the one or more swivel brackets 408 in a micropile column may be levelled relative to one another using a laser, a string-line, eyesight, a straight-beam, a level, GPS, or any other suitable method prior to installation of the solar modules. In this alternative method, the levelling screw 403 would be engaged in the manner described in regard to FIGS. 11A to 11C to change the elevation of one or more swivel brackets 408. In this example method, a reference point on a swivel bracket 408 may be used to ensure that the swivel brackets 408 in the column are substantially co-planar, such as within 5 to 50 millimeters of an average plane. The reference point may be the lower distal end of the crimp tube 402, the module contact flange 416, the pivot fastener 405, or other suitable feature.

As a potential next step, after the swivel brackets 408 in the column have been levelled, one or more crimp tubes 402 on the now-levelled swivel bracket 408 may be crimped by any of the methods described in the discussion of FIGS. 12 and 13. For a first column of solar modules 103 in a solar module array 100, the first and second columns of swivel brackets 408 may be levelled and transitioned to swivel bracket 408′ by crimping the crimp tube. A plurality of swivel brackets 408 may be placed on the respective micropiles in a third or more micropile columns, but may not yet be levelled and transitioned from swivel bracket 408 to swivel bracket 408′.

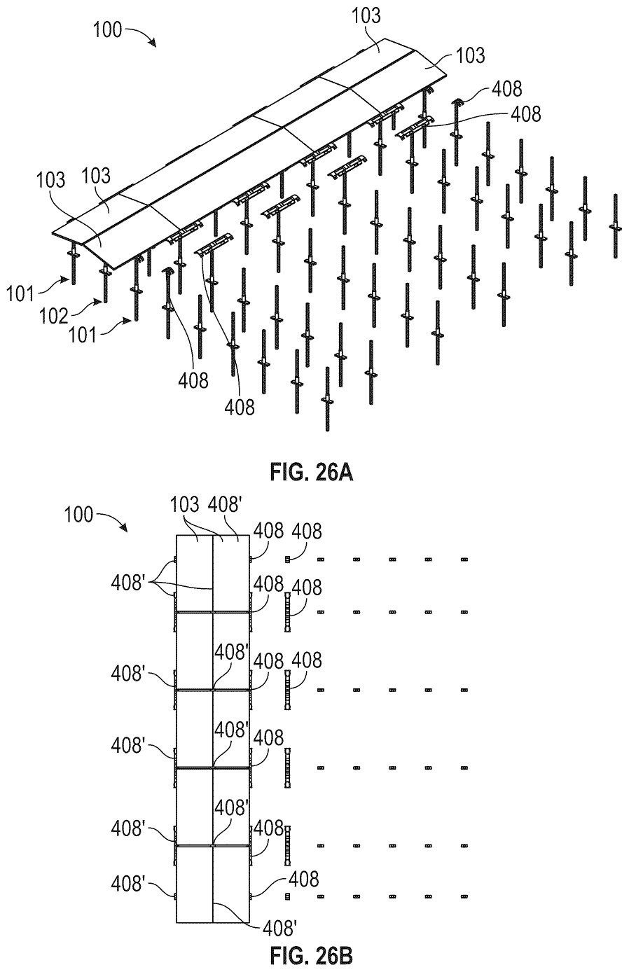

FIGS. 26A and 26B are isometric and top-down views respectively of a solar module array 100 where a second column of the array has been installed onto a second column of transitioned swivel brackets 408′ and a third column of non-transitioned swivel brackets 408, representing one example embodiment of the present invention. In this step, the first two columns of transitioned swivel brackets 408′ are secured to micropiles, and one or more solar modules 103 in the second column of solar modules may be attached to the third column of swivel brackets 408 using one or more module clamps 500 (not shown). The third column of swivel brackets 408 may be levelled and secured to the third column of micropiles, with transitioned swivel brackets 408′, before a third column of solar modules is installed. In some example methods, adjacent micropile columns may be installed only after one or more solar modules are installed on a previous micropile column.

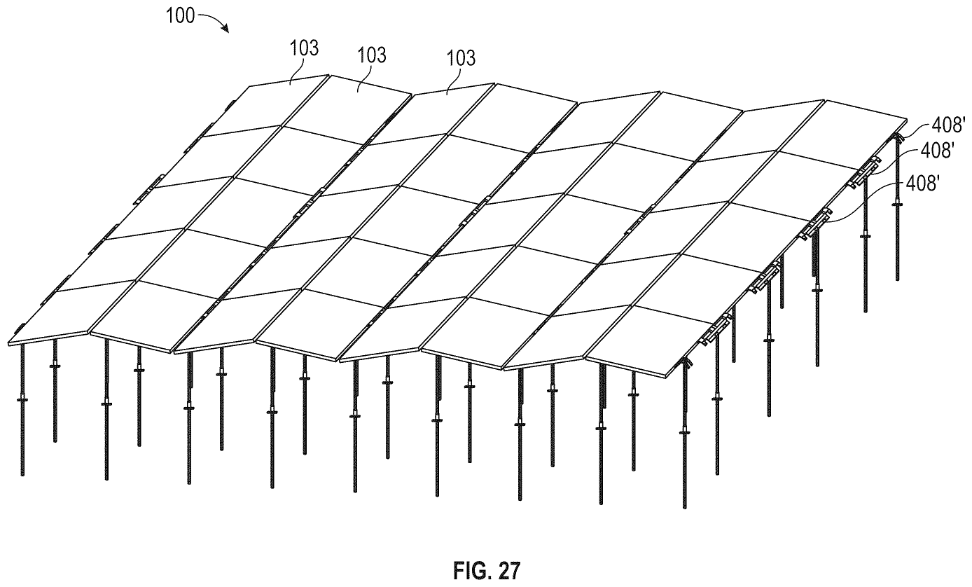

FIG. 27 is an isometric view of a solar module array 100 where all solar modules 103 have been installed and all swivel brackets 408′ are levelled and secured to all micropiles 200, representing one example embodiment of the present invention.

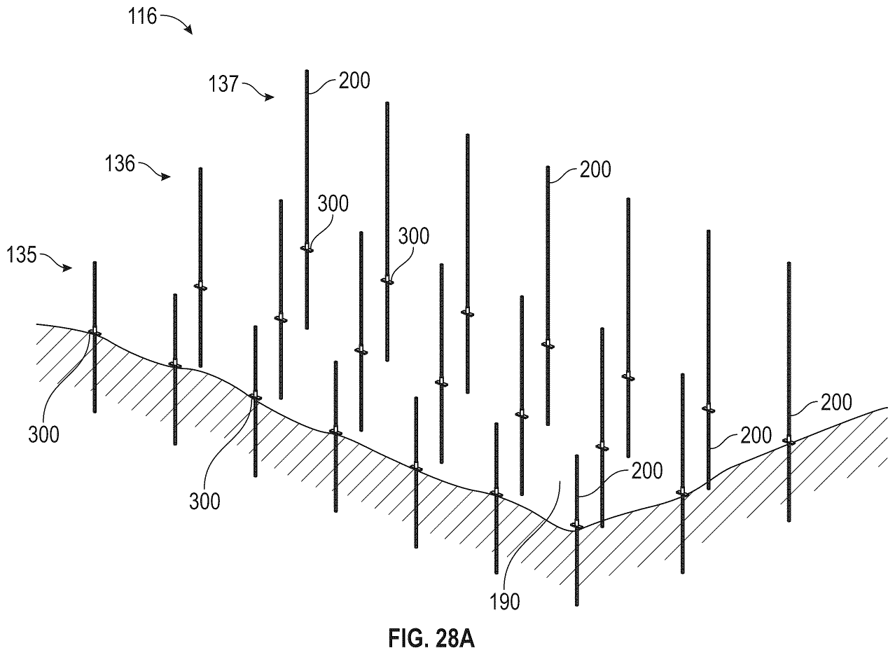

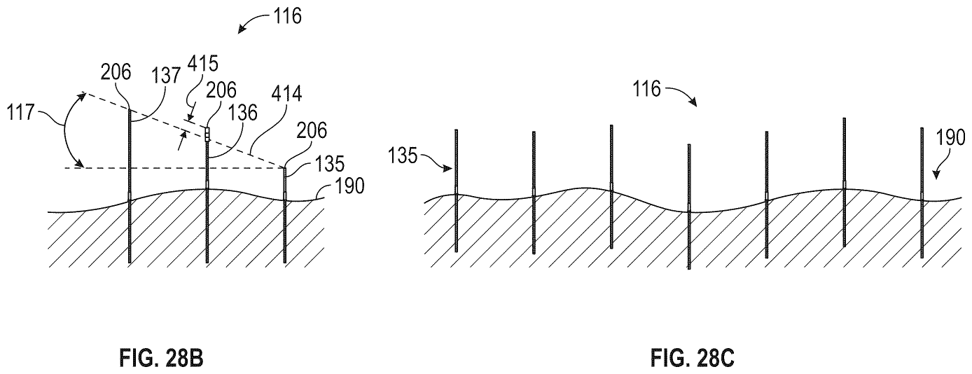

FIGS. 28A through 28C are isometric, side, and front views of a solar module array 100 configured as an equatorial facing solar array 116 using the same components as previously described, representing one example embodiment of the present invention. FIG. 28A depicts a plurality of micropiles installed into a terrain 190 and arranged in a first micropile row 135, a second micropile row 136, and a third micropile row 137. In most embodiments, the average elevation of the micropile tips 206 in the second micropile row 136 will be higher than the average elevation of micropile tips in the first micropile row 135. Additionally, the average elevation of the micropile tips in the third micropile row 137 will be higher than the average elevation of micropile tips in the second micropile row 136. As such, referring to FIG. 28B, the elevation plane 414 may form an equatorial module tilt angle 117 with earth horizon, and angled towards the equator. In some example embodiments, the equatorial module tilt angle 117 may be between zero and forty-five degrees, and may be set based on the latitude of an equatorial facing solar array 116.

As described in regard to FIG. 16, the micropile tips 206 may be installed in the terrain 190 so that the offset from the elevation plane 415 is less than the maximum value of the levelling height 413, or in other cases within one hundred millimeters from elevation plane 415. FIG. 28C is a side view of the first micropile row 135.

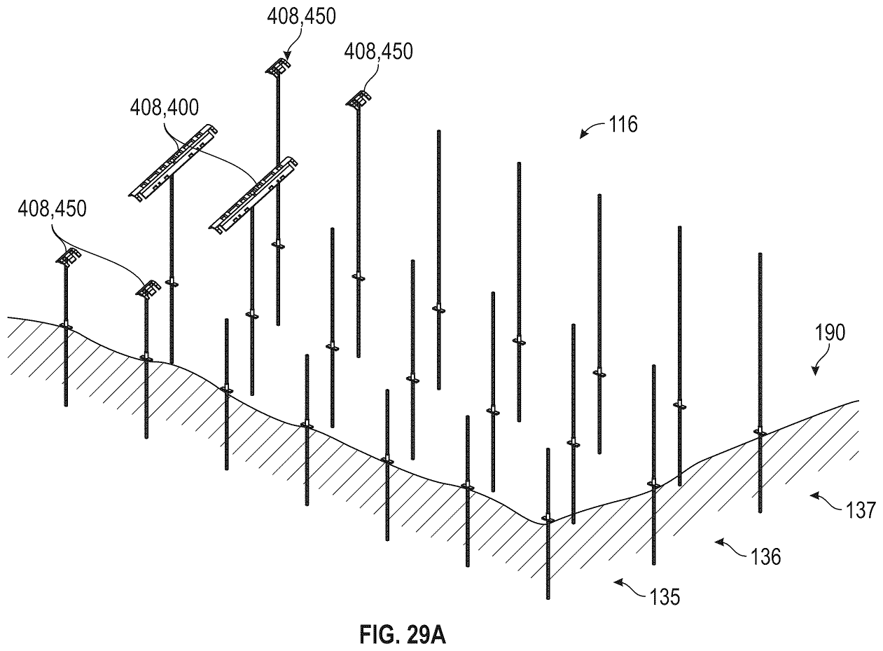

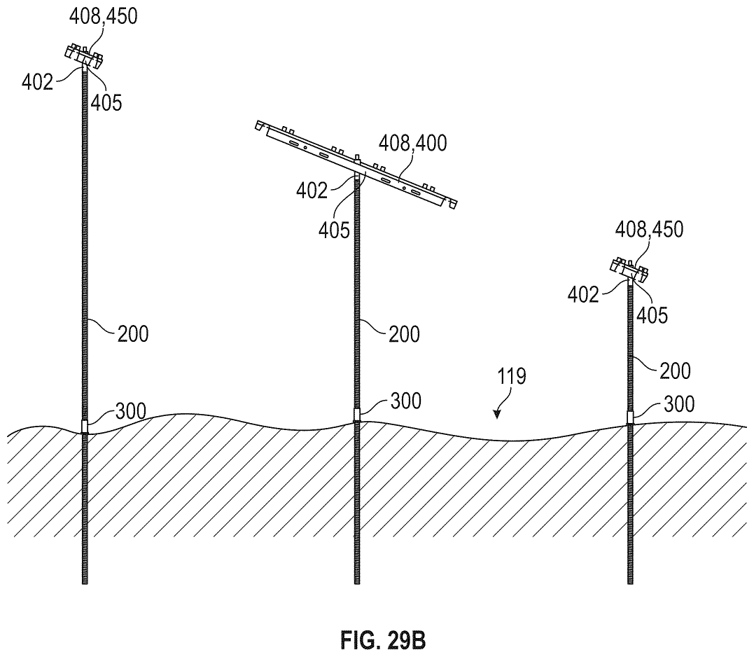

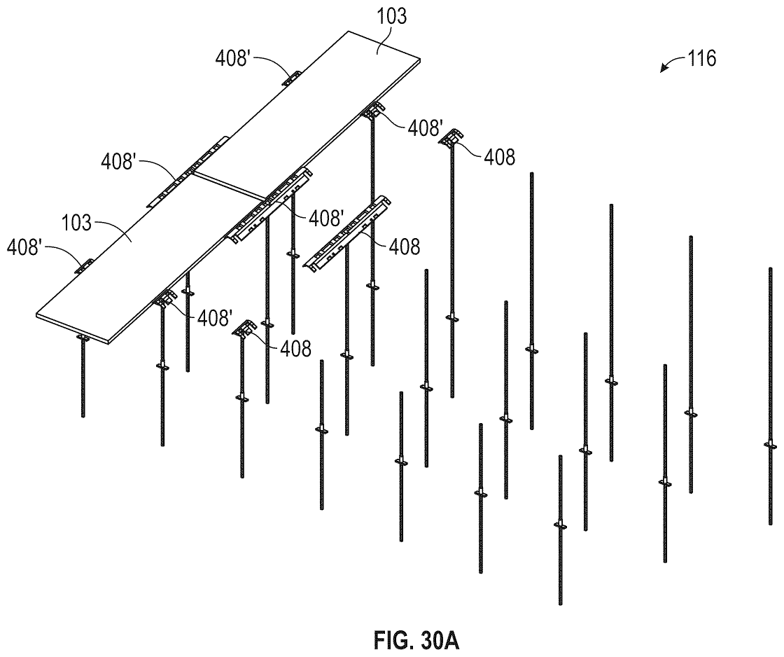

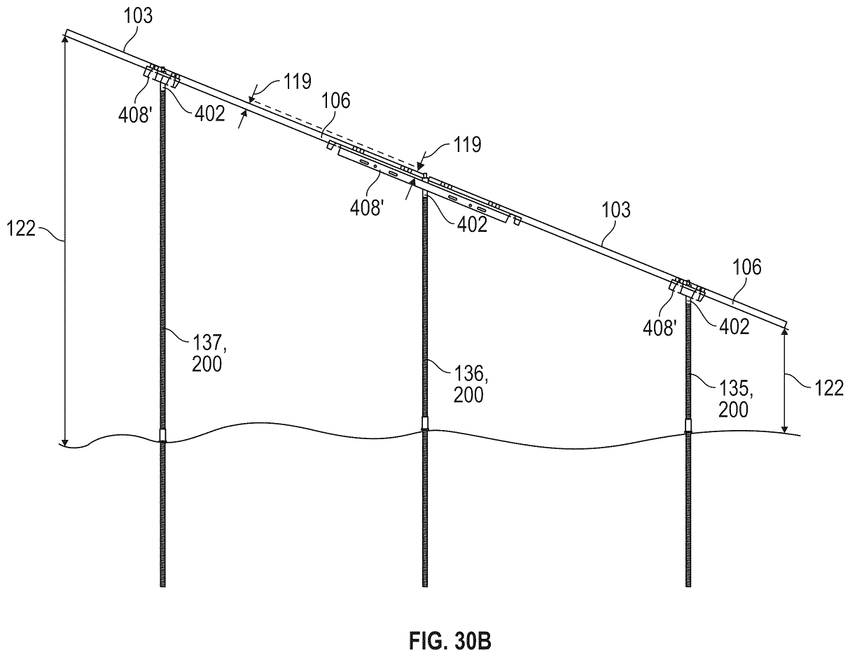

FIGS. 29A and 29B are isometric and side views, respectively, of a potential next step in the installation of an equatorial facing solar array 116, representing one example embodiment of the present invention. In this step, a swivel bracket 408, configured either as a mid-swivel bracket assembly 400 or an end-swivel bracket assembly 450, is placed on the first two micropile columns. The swivel bracket 408 may pivot around a pivot fastener 405 so that one or more swivel brackets 408 in a column of swivel brackets 408 are substantially co-planar. Although not shown, the levelling screw tip 410 may abut the micropile tip 206, in a process exactly the same as shown in FIGS. 10A to 10C. The levelling screw 403 may then be engaged to align the module contact flange 416 from an adjacent swivel bracket 408 in a column of swivel brackets to be more precisely co-planar, such as within less than 20 or 10 millimeters, as described in FIGS. 11A to 11C. In other example processes, the levelling screw 403 may not be engaged, and the installation procedure can continue to the steps shown in FIGS. 30A and 30B.

FIGS. 30A and 30B depict isometric and side views of an equatorial facing solar array 116, where one or more solar modules 103 are secured to their respective swivel brackets 408 using one or more module clamps 500 (not shown), representing one example embodiment of the present invention. If adjacent solar modules in a solar module column are not substantially co-planar, one or more levelling screws 403 may be adjusted to raise or lower a swivel bracket 408 to make the adjacent solar modules substantially co-planar. In some cases, one or more swivel brackets 408 may be adjusted so that adjacent solar modules 103 are co-planar within 50 millimeters per meter along their primary length, and in other cases within 15 millimeters.

The equatorial facing solar array 116 may be configured so that the areray-to-terrain clearance 122 is greater than 8 inches at a low end and less than 120 inches at a high end.

As a potential next step, the crimp tubes 402 may be transitioned to crimped form 402′, and the swivel brackets 408 transitioned likewise to fixed form 408′, after one or more swivel brackets 408 have been levelled as described above. The transition of a swivel bracket may occur after the solar modules 103 are installed, such as depicted in FIG. 30B, or when one or more swivel brackets 408 in a column of swivel brackets 408 are levelled and axially adjusted around the primary axes of the micropiles to render the swivel brackets in a column of swivel brackets substantially co-planar, such as within 50 millimeters or 15 millimeters of one another. In other words, referring to FIG. 30B, the plane offset dimension 119 may be adjusted to be less than 50 millimeters for every 1 meter in length along the length of solar module 103. At this stage, one or more swivel brackets 408 may be placed on an adjacent, vacant micropile in the equatorial facing solar array 116.

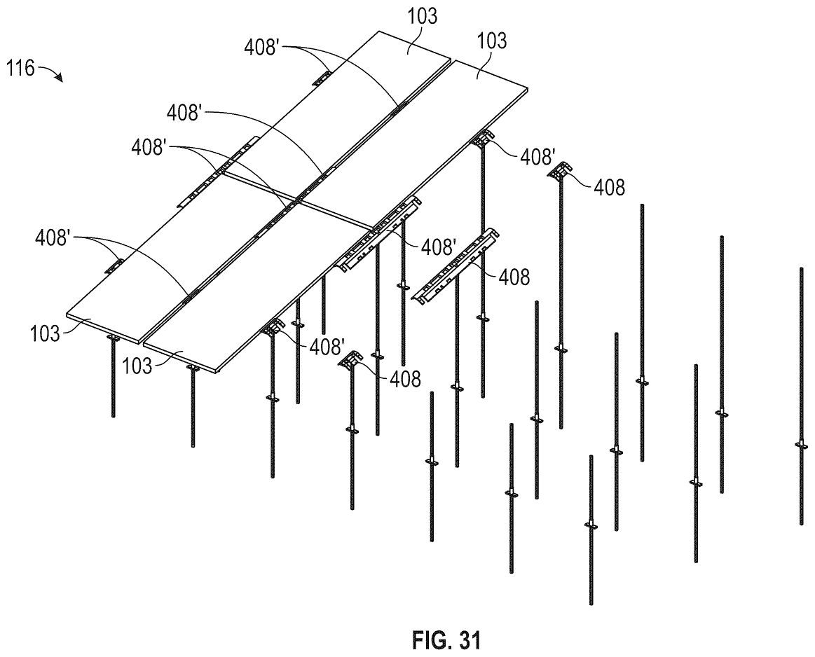

FIG. 31 depicts a potential next step, where a second column of solar modules 103 is installed and secured to a next set of swivel brackets 408 using one or more module clamps 500 (not shown). The third column of swivel brackets 408 may be transitioned to their transitioned form.

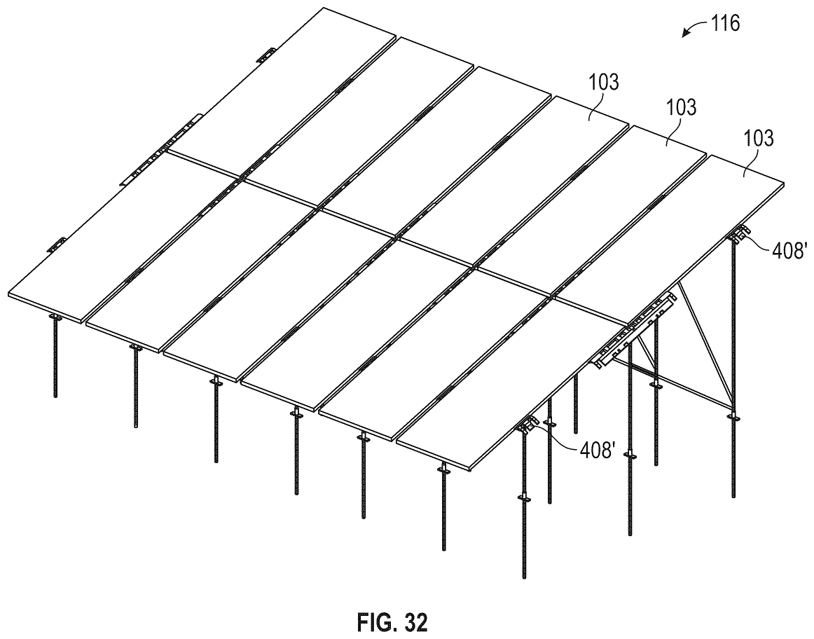

FIG. 32 is an isometric view of a completed equatorial facing solar array 116, representing one example embodiment of the present invention.

In other example embodiments not shown, the solar modules 103 may be rotated 90 degrees and installed in a portrait orientation, rather than a landscape orientation.

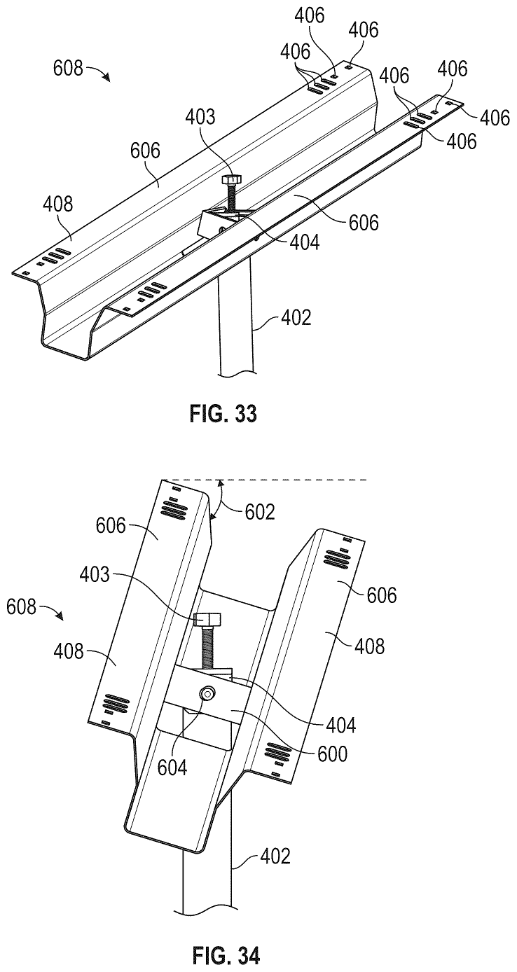

FIGS. 33 through 44 represent an alternative embodiment to the present invention. FIGS. 33 through 35 depict various isometric views of an alternative swivel bracket assembly, configured as a centerline swivel assembly 608. In this example, centerline swivel assembly 608 is still assembled in the same way as depicted in FIGS. 2 through 7, however a universal joint 600 pivotally connects 408 to 402. universal joint 600 is pivotally connected to 408 along its long-side centerline, and 402 is connected to universal joint 600 along a perpendicularly oriented pivot axis. This allows 408 to pivot in two axis simultaneously relative to 402. FIG. 33 also depicts the use of 404 to threadably engage 403, as exemplified in FIG. 5, however the other configurations of 402 as depicted in FIGS. 6 and 7 are also contemplated. 408 may be symmetric along its lengthwise centerline, with module support flange 606 extending laterally away from the centerline and configured to support solar module frame 106. At least one module clip aperture 406 may be disposed on either end of both module support flange 606, as shown. module clip aperture 406 may be a series of slots, rectangular apertures, or other shapes configured to engage with a 500 or module fastener 601 (not shown).

The swivel bracket 408 may have a uniform cross section along the majority of its length except for various apertures. The swivel bracket 408 may be made from coated steel or aluminum, using an extrusion, roll forming, stamping or other suitable manufacturing process. 408 may have a uniform thickness of 0.5 millimeters to 2.0 millimeters. All bend radii of 408 may be at least one-times the thickness, and in some examples two-times. For example, if 408 is made of 1.0 millimeter thick material, all bends may have a radius of at least 1.0 millimeters.

FIG. 34 is a plan-front view of centerline swivel assembly 608 depicting 408 swiveled in two axis relative to 402. In this view, 402 is shown vertically, and 408 is pivoted around NS pivot axis 604 to form NS tilt angle 602. Typical the NS tilt angle 602 will be in the North-South direction when centerline swivel assembly 608 is installed (as seen in later Figures). The geometry of universal joint 600 and 408 may be such to allow NS tilt angle 602 to pivot a range from negative thirty to positive 30 degrees. universal joint 600 may be connected to 402 using a fastener, such as a rivet, bolt, pin, or other suitable device.

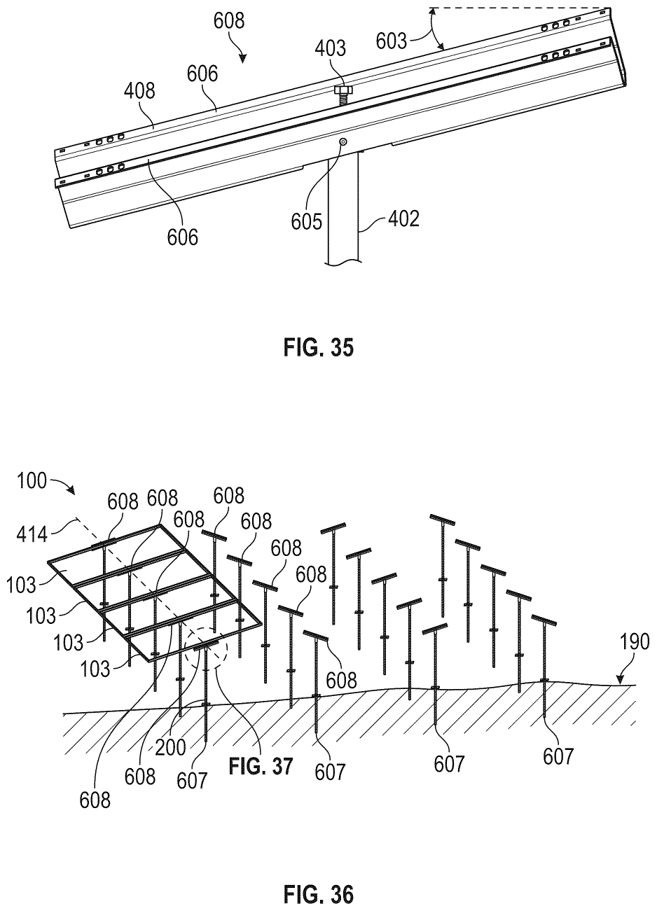

FIG. 35 is a plan-side view of FIG. 34. This view illustrates 408 also pivoted around EW pivot axis 605 to form EW tilt angle 603. Likewise, the geometry of universal joint 600 and 408 may be such to allow NS tilt angle 602 to pivot a range from negative thirty to positive 30 degrees.

FIGS. 36 through 41 depict various views of a potential installation method similar to the process described in FIGS. 14 through 27. FIG. 36 depicts a potential next steps after the process described for FIGS. 14 through 17, however 200 may be installed as micropile column 607 with substantially similar elevations (versus “short” and “tall” micropile columns as described in FIGS. 14 through 17). Similar to FIG. 18A, a centerline swivel assembly 608 is placed on each micropile 200, however the same centerline swivel assembly 608 component is used on all micropile 200 within a micropile column 607. Additionally, each centerline swivel assembly 608 is oriented with its long-side oriented in substantially the East-West direction. Then a first set of 103 are installed in a module column on a first micropile column 607, as depicted.

FIG. 37 is a close up isometric view of a first centerline swivel assembly 608 in a first micropile column 607, depicting centerline swivel assembly 608 installed on micropile 200 and solar module 103 connected to centerline swivel assembly 608 using at least one module fastener 601. In this view, the solar cells and glass of 103 are hidden to show solar module frame 106 and module fastener 601. module fastener 601 may be a fastener, such as a rivet, swedge bolt, bolt, pin, or other suitable fastening device configured to pass through an aperture disposed on solar module frame 106 and a module clip aperture 406 to clamp and secure solar module frame 106 to centerline swivel assembly 608. Once installed, module fastener 601 may create an electrical bond bath from solar module frame 106 to centerline swivel assembly 608. In other alternative embodiments not shown, solar module frame 106 may be clamped to centerline swivel assembly 608 using one or more module clamps 500, such as depicted in FIG. 1. solar module frame 106 may be installed onto centerline swivel assembly 608 such that the distal end of levelling screw 403 is accessible after one, two, three, or four 103 are installed onto a centerline swivel assembly 608. Solar module 103 may be installed in a portrait orientation, where the long edge of solar module 103 forms EW tilt angle 603.

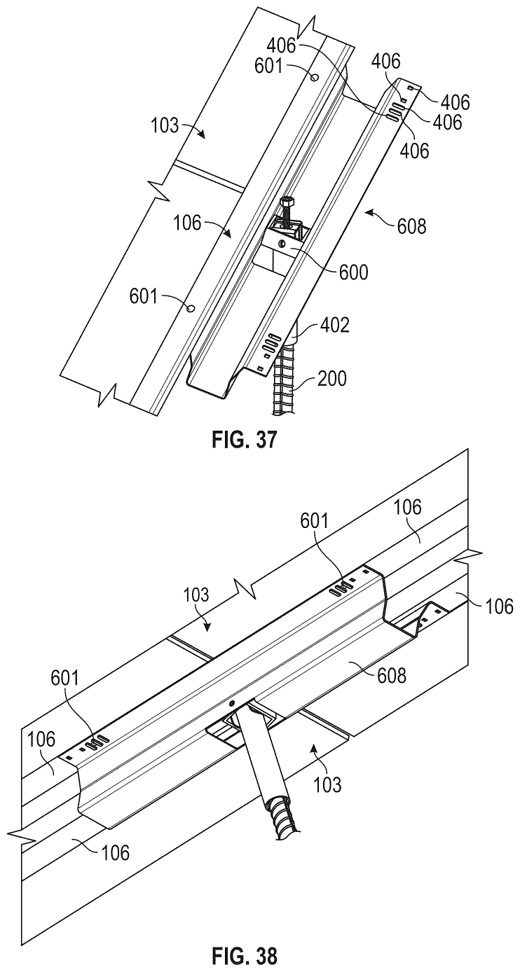

FIG. 38 depicts an underside view looking skyward from under solar module array 100 of a centerline swivel assembly 608 at a mid-location along micropile column 607 supporting two solar modules 103. A pair of module fasteners 601 are visible securing a first 103 to EW tilt angle 603, yet a second pair hidden from view is also installed securing a second solar module 103 to centerline swivel assembly 608.

In a potential next step, this first module column may be levelled in the same manner as described for FIGS. 22 through 25B, however elevation plane 414 may be along the mid-plane of the modules (i.e. along the centerline of the micropile column 607), rather than on the edges of the modules. In this example embodiment, plane offset dimension 119 would be measured also along the centerline bisecting the column of solar modules 103.

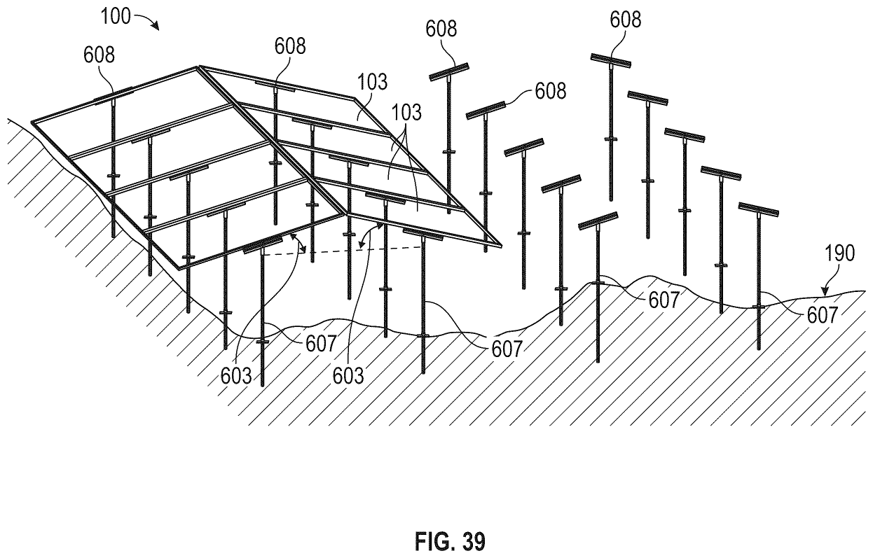

FIG. 39 depicts a potential next step where a second column of modules is installed onto a second micropile column 607. The first and second module columns may have substantially equal yet opposite EW tilt angle 603, as depicted. The second module is installed to the second micropile column 607 in the same way described in FIGS. 36 through 38.

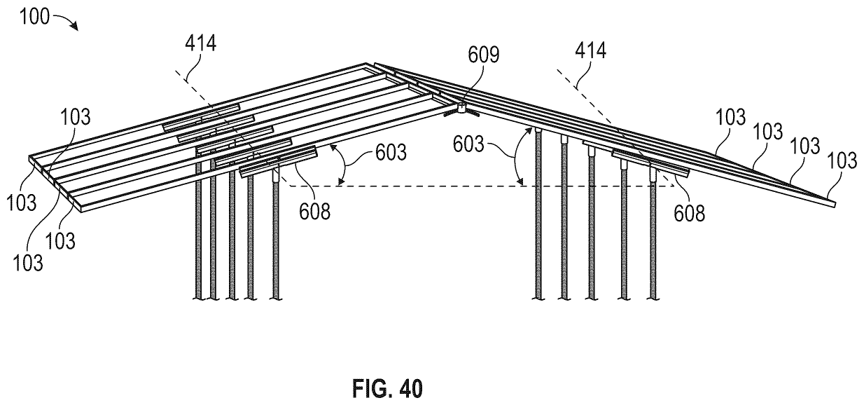

FIG. 40 depicts a first and second module columns in a levelled to be substantially coplanar to their respective elevation plane 414. At least one Module column connector 609 may be installed to structurally connect and electrically bond a first module column to a second module column. Module column connector 609 may install at all pairs of long edges of modules pairs, such as two Module column connector 609 per pair of opposite facing modules. Module column connector 609 may clamp onto the frames of the respective modules using a bolt, fastener, rivet, swedge-bolt, clip-on slide, or other suitable means. Module column connector 609 may be installed as each module in a second column of modules is installed.

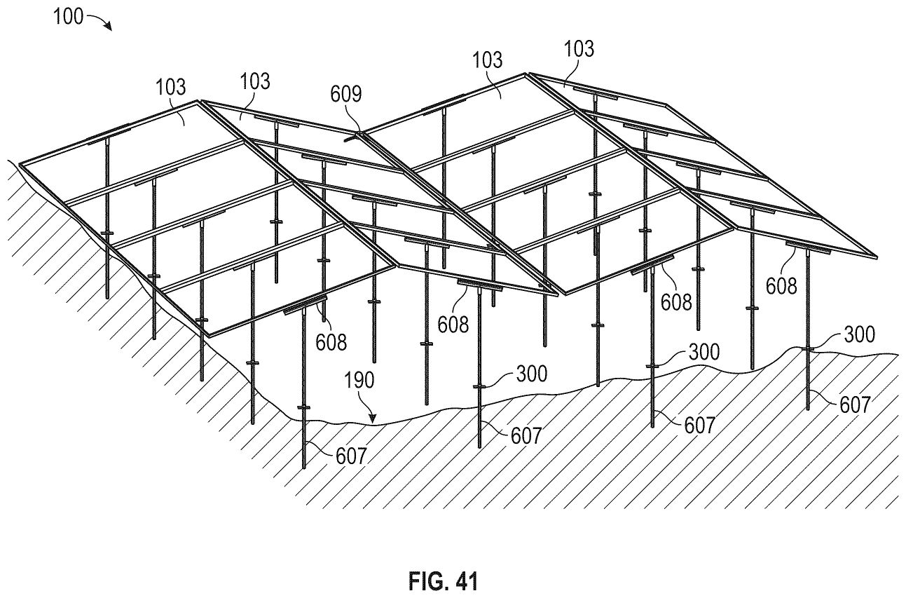

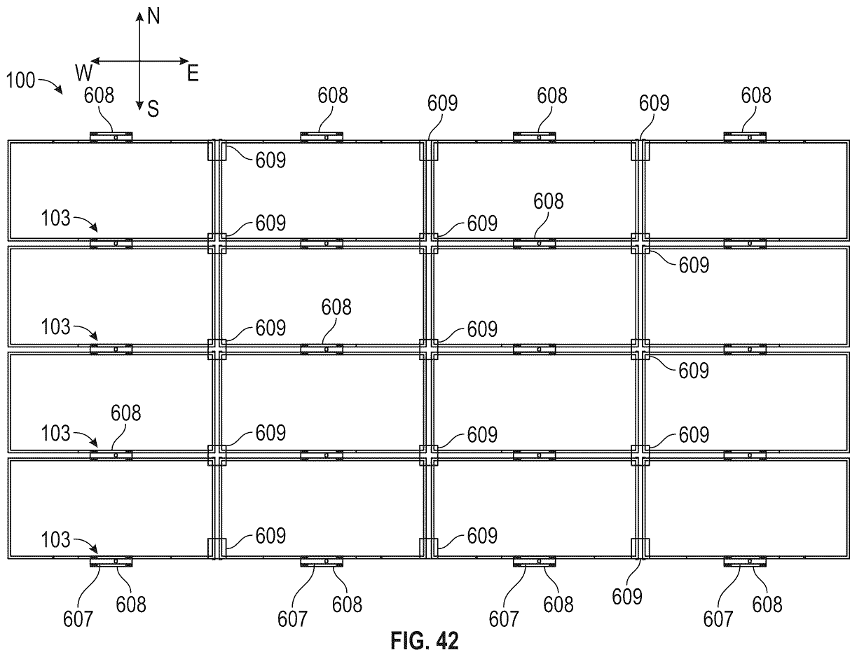

FIG. 41 depicts an isometric view of a completed 100. In this embodiment, the quantity of micropile 200 and 608 sets per micropile column 607 are equal to the number of solar modules 103 in a module column plus one.

FIG. 42 depicts a top-down view of FIG. 41. The modules in the first module column and second module column are connected to one another using at least one Module column connector 609. In the first row of modules, a Module column connector 609 is installed to connect two adjacent solar modules 103, and a second Module column connector 609 is installed connecting four adjacent modules. In other example embodiments, Module column connector 609 may be configured to only connect two solar modules along their long side, and thus each pair of solar modules would be connected to each other by at least two Module column connector 609. Module column connector 609 may be at least two pieces connected with a pivot point in order to accommodate a row-pair of modules at a variety of EW tilt angles 603. As depicted, Module column connectors 609 are only installed at the peak edges of adjacent solar modules, but in other example embodiments not shown, two sides of Module column connector 609 may pivot to connect to adjacent solar modules at the trough edges of adjacent solar modules.

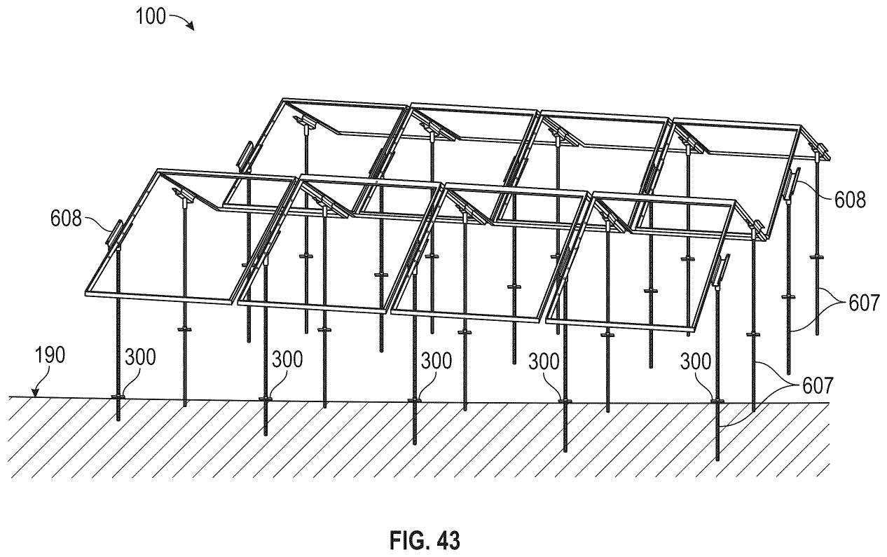

FIG. 43 depicts a side isometric view looking predominantly East or Westward, with 100 installed into substantially flat 190. In this example, NS tilt angle 602 is substantially near zero, while EW tilt angle 603 is at a positive or negative angle depending on the module column. In most examples, EW tilt angle 603 will alternate positive or negative from one column to the next.

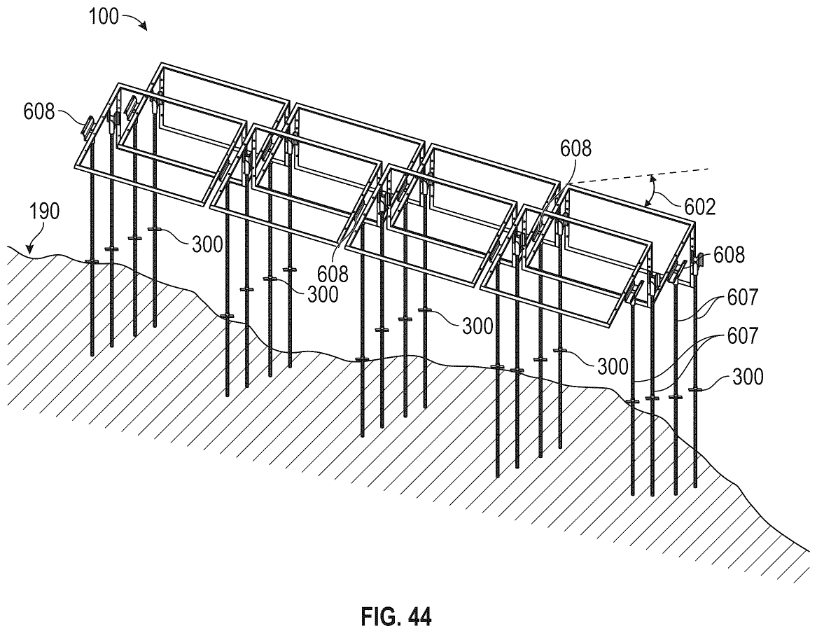

FIG. 44 depicts a side isometric view looking predominantly East or Westward, with 100 installed into angled 190. Modules may have a similar EW tilt angle 603 compared with FIG. 43, but NS tilt angle 602 is at an angle substantially similar to the average slope of 190.

What is claimed is:

1. A swivel bracket assembly for mounting to a micropile, the assembly comprising:
a swivel bracket;
a crimp tube shaped to fit over a distal segment of the micropile as a sleeve, the crimp tube crimpable to seize the micropile; and
a leveling screw configured to threadably engage the swivel bracket at an upper end of the distal segment of the micropile and to extend into the crimp tube when engaged, wherein the leveling screw is rotated to change a position of the swivel bracket relative to the micropile.

2. The swivel bracket assembly of claim 1, further comprising a levelling screw plate at a distal end of the crimp tube, the levelling screw plate having a threaded aperture therein configured to threadably engage the levelling screw.

3. The swivel bracket assembly of claim 1, wherein the crimp tube includes a central threaded aperture and at least one end that is axially flattened, the central threaded aperture sized to threadably engage the levelling screw.

4. The swivel bracket assembly of claim 1, wherein the crimp tube includes a cavity that is at least partially enclosed at one end adjacent to a central threaded aperture and that becomes fully enclosed when the central threaded aperture threadably engages the levelling screw.

5. The swivel bracket assembly of claim 1, wherein the crimp tube is pivotally joined to the swivel bracket.

6. The swivel bracket assembly of claim 1, wherein the swivel bracket has a centerline, and the crimp tube is joined to the swivel bracket in a pivotal manner around the centerline.

7. The swivel bracket assembly of claim 1, wherein engaging the levelling screw by different amounts results in adjusting a height of the swivel bracket assembly above a tip of the micropile, the height adjustable within a range of zero to 250 millimeters.

8. The swivel bracket assembly of claim 1, wherein the swivel bracket is configured to rotate about an axis of the micropile before the crimp tube is crimped to seize the micropile.

9. The swivel bracket assembly of claim 1, wherein the micropile is a length of rebar that is 0.5 to 1.0 inch in diameter.

10. A method of installing a swivel bracket assembly, the method comprising:
aligning a crimp tube coaxially with a micropile protruding vertically above a terrain, wherein a levelling screw extends inside the crimp tube;
lowering a swivel bracket assembly threadably engaged to the levelling screw onto the micropile until the leveling screw abuts an upper distal end of the micropile; and
rotating the leveling screw to adjust a height of the swivel bracket assembly to a selected height above the terrain.

11. The method of claim 10, further comprising crimping the crimp tube over the micropile to seize the micropile.

12. The method of claim 10, further comprising threadably engaging the levelling screw in a threaded aperture of a levelling screw plate at a distal end of the crimp tube.

13. The method of claim 10, further comprising threadably engaging the levelling screw in a central threaded aperture adjacent to at least one end of the crimp tube, wherein the at least one end is axially flattened.

14. The method of claim 10, wherein the crimp tube includes a cavity that is at least partially enclosed at one end adjacent to a central threaded aperture, and further comprising threadably engaging the levelling screw in the threaded central aperture, wherein the at least one end of the becomes fully enclosed when the central threaded aperture threadably engages the levelling screw.

15. The method of claim 10, wherein the crimp tube is pivotally joined to the swivel bracket.

16. The method of claim 10, wherein the swivel bracket has a centerline, and the crimp tube is joined to the swivel bracket in a pivotal manner around the centerline.

17. The method of claim 10, further comprising fastening the crimp tube to the swivel bracket in pivotal manner around a centerline of the swivel bracket.

18. The method of claim 10, wherein lowering the swivel bracket assembly includes adjusting the height of the swivel bracket assembly within a range of zero to 250 millimeters.

19. The method of claim 11, wherein the swivel bracket is configured to rotate about an axis of the micropile before the crimp tube is crimped over the micropile.

20. The method of claim 11, wherein the crimp tube is crimped in a polygonal configuration around the micropile.

21. The method of claim 10, wherein the micropile is a length of rebar that is 0.5 to 1.0 inch in diameter.

22. A method of levelling a column of solar modules in solar module arrays relative to a plane, the method comprising:
rotating a levelling screw of a swivel bracket assembly to which an offset solar module is mounted to reduce at least a portion of offset, wherein the offset solar module is part of a column of solar modules in a solar module array mounted to a plurality of micropiles using one or more swivel bracket assemblies including swivel brackets, crimp tubes, and leveling screws, and wherein one or more other solar modules within a column of the solar module array have an edge that aligned to a plane, and the offset solar module has an edge that is offset from the plane.

23. The method of claim 22, wherein the levelling screw of the swivel bracket assembly to which the offset solar module is mounted is rotated so as to reduce the offset to less than 50 millimeters.

24. The method of claim 22, wherein each of the swivel bracket assemblies are coplanar to within less than 50 millimeters of each other of the swivel bracket assemblies.

25. The method of claim 24, further comprising levelling the solar modules to reduce the offset to within 50 millimeters of the plane when the solar modules within the solar module array are at various heights above an uneven terrain.

26. The method of claim 22, further comprising crimping the crimp tubes over the micropiles to secure the swivel bracket assembles to the micropiles after the swivel brackets are levelled.

27. The method of claim 25, wherein the swivel bracket assembles are pivotally joined to the crimp tubes and pivotable to angles that are non-perpendicular to the micropiles.

28. The method of claim 22, further comprising pivotally adjusting the swivel brackets to be parallel with one another along a terrain that is angled relative to a horizon, wherein the micropiles are perpendicular to the horizon.

29. A method of installing a solar module array over a terrain, the method comprising:
installing a first column and a second column of micropiles in the terrain;
mounting a swivel bracket assembly onto each of the micropiles, wherein the swivel bracket assembly includes a swivel bracket, a crimp tube, and a leveling screw;
mounting a plurality of solar modules onto the swivel bracket assembly to form a solar module column within which a set of the solar modules have edges that are substantially coplanar except for at least one of the solar modules having a corresponding edge that is offset by an offset dimension that is at least 50 millimeters along a 1000 millimeter length of the column; and
rotating the levelling screw of the swivel bracket assembly to which the at least one offset solar module is mounted so as to render the corresponding edge of the offset solar module coplanar with the edges of the set of solar modules in the column.

30. The method of claim 29, further comprising:
installing a third column of micropiles in the terrain;
mounting swivel bracket assembles to the micropiles in the third column;
mounting solar modules onto the swivel bracket assemblies in the third column; and
rotating leveling screws of the swivel bracket assemblies of the third column to render edges of the solar modules of the third column to be coplanar.

31. The method of claim 29, wherein rotating the leveling screw of the swivel bracket assembly includes reducing the offset dimension to less than 50 millimeters.

32. The method of claim 29, wherein at least one of the first column and the second column of micropiles is installed such that micropile tips of the at least one column are coplanar within 150 millimeters.

33. The method of claim 29, further comprising crimping crimp tubes over the micropiles to secure the swivel bracket assembles to the micropiles after levelling of the offset solar module.

34. The method of claim 29, wherein at least one of the first column and the second column of micropiles is installed such that micropile tips of the at least one column are coplanar within half of a levelling height of one another.
